(19) United States
(12) Patent Application Publication
(10) Pub. No.: US 2009/0327323 A1
(43) Pub. Date: Dec. 31, 2009

(54) Integrating Data Resources by Generic Feed Augmentation

(75) Inventors: Mehmet Altinel, San Jose, CA (US); Volker G. Markl, Raubling (DE); David E. Simmen, San Jose, CA (US); Ashutosh Singh, San Jose, CA (US)

Correspondence Address: Walder Intellectual Property Law PC, 17330 Preston Road, Suite 100B, Dallas, TX, 75252, US

(73) Assignee: International Business Machines Corporation, Armonk, NY (US)

(21) Appl. No.: 12/163,302

(22) Filed: Jun. 27, 2008

(51) Int. Cl. G06F 17/30

(52) U.S. Cl. 707/101; 707/E17.009

(57) ABSTRACT

Data integration in a data processing system is provided. A data mashup specification is received and an interleaved sequence of operations as defined by the data mashup specification is executed. The interleaved sequence of operations comprises at least one of an import operation, an augment operation, or a publish operation. In executing the interleaved sequence of operations a determination is made as to the next operation to execute. An outer context is formed and added to a binding context of the next operation. If the next operation is an import operation, a data resource is imported from a data source and an input generic feed is generated. If the next operation is an augment operation, a set of augmented generic feeds is produced from a set of input generic feeds. If the next operation is a publish operation, a new data resource is produced from a specified augmented generic feed.

### BACKGROUND OF THE INVENTION

1. Field of the Invention

The present application relates generally to an improved data processing apparatus and method and more specifically to an apparatus and method for performing a derivation of augmented serialized data sets from base serialized data sets.

2. Background of the Invention

Currently, there are two important trends motivating new enterprise information integration methods. The first trend is happening inside the enterprise where there is an increasing demand by enterprise business leaders to be able to exploit information residing outside traditional information technology (IT) silos in efforts to react to situational business needs. The predominant share of enterprise business data resides on desktops, departmental files systems, and corporate intranets in the form of spreadsheets, presentations, email, Web services, HyperText Markup Language (HTML) pages, etc. There is a wealth of valuable information to be gleaned from such data; consequently, there is an increasing demand for applications that may consume the data, combine the data with data in corporate databases, content management systems, and other IT managed repositories, and then to transform the combined data into timely information.

Consider, for example, a scenario where a prudent bank manager wants to be notified when a recent job applicant's credit score dips below 500, so that she might avoid a potentially costly hiring mistake by dropping an irresponsible applicant from consideration. Data on recent applicants resides on her desktop, in a personal spreadsheet. Access to credit scores is available via a corporate database. She persuades a contract programmer in the accounting department to build her a Web application that combines the data from these two sources on demand, producing an Atom feed that she may view for changes via her feed reader.

The second trend is happening outside the enterprise where the Web has evolved from primarily a publication platform to a participatory platform, spurred by Web 2.0 paradigms and technologies that are fueling an explosion in collaboration, communities, and the creation of user-generated content. The main drivers propelling this advancement of the Web as an extensible development platform is the plethora of valuable data and services being made available, along with the lightweight programming and deployment technologies which allow these “resources” to be mixed and published in innovative new ways.

Standard data interchange formats such as Extensible Markup Language (XML) and JavaScript™ Object Notation (JSON), as well as prevalent syndication formats such as Really Simple Syndication (RSS) and Atom, allow resources to be published in formats readily consumed by Web applications, while lightweight access protocols, such as Representational State Transfer (REST), simplify access to these resources. Furthermore, Web-oriented programming technologies like Asynchronous JavaScript™ and XML (AJAX), Php: Hypertext Preprocessor (PHP), and Ruby on Rails™ enable quick and easy creation of “mashups”, which is a term that has been popularized to refer to composite Web applications that use resources from multiple sources.

### BRIEF SUMMARY OF THE INVENTION

In one illustrative embodiment, a method, in a data processing system, is provided for data integration in a data processing system. The illustrative embodiments receive a data mashup specification and execute an interleaved sequence of operations as defined by the data mashup specification. In the illustrative embodiments, the interleaved sequence of operations comprises at least one of an import operation, an augment operation, or a publish operation. In executing the interleaved sequence of operations, the illustrative embodiments determine a next operation to execute, form an outer context, and add the outer context to a binding context of the next operation. Responsive to the next operation being the import operation, the illustrative embodiments import a data resource from a data source and generating an input generic feed. Responsive to the next operation being the augment operation, the illustrative embodiments produce a set of augmented generic feeds from a set of input generic feeds. Responsive to the next operation being the publish operation, the illustrative embodiments produce a new data resource from a specified augmented generic feed.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the exemplary embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an exemplary distributed data processing system in which aspects of the illustrative embodiments may be implemented;

FIG. 2 shows a block diagram of an exemplary data processing system in which aspects of the illustrative embodiments may be implemented;

FIG. 3 depicts an exemplary data integration mechanism in accordance with an illustrative embodiment;

FIG. 4 depicts one exemplary data mashup in accordance with an illustrative embodiment;

FIG. 5 shows an exemplary Comma-Separated Values (CSV) representation of policy holder data in accordance with the illustrative embodiment;

FIG. 6 illustrates an output of one straightforward implementation of an ingestion function that maps CSV formatted data to an XML representation in accordance with an illustrative embodiment;

FIG. 7 illustrates a final generic feed of CSV data resource representing policy holders in accordance with an illustrative embodiment;

FIG. 8 depicts a RSS feed input to an Import operator in accordance with an illustrative embodiment;

FIG. 9 depicts a generic feed output that is output by an Import operator in accordance with an illustrative embodiment;

FIG. 10 illustrates a merged output from a Merge operator for an input generic feed data produced by Import operators in accordance with an illustrative embodiment;

FIG. 11 depicts an output from a Publish operator for a input generic feed in accordance with an illustrative embodiment;

FIG. 12 shows an exemplary XQuery expression that implements an Import operator in accordance with an illustrative embodiment;

FIG. 13 shows a general PHP script for generating an XQuery expression that implements data manipulation logic of an Import operator in accordance with an illustrative embodiment;

FIG. 14 provides an additional example of how an operator's data manipulation logic may be implemented using an XQuery expression in accordance with an illustrative embodiment;

FIGS. 15A and 15B show an exemplary output of an XQuery expression given a generic feed in accordance with an illustrative embodiment;

FIG. 16 depicts an output of a Filter operator that applies a filter condition to a generic feed in accordance with an illustrative embodiment;

FIG. 17 depicts an XQuery expression that implements data manipulation logic of a Filter operator in accordance with an illustrative embodiment;

FIG. 18 depicts an output of applying a Group operator with a group expression and nest expressions to an input feed in accordance with an illustrative embodiment;

FIG. 19 illustrates an XQuery expression that implements data manipulation logic of a Group operator instance in accordance with an illustrative embodiment;

FIG. 20 depicts an input feed for a Transform operator which may be used to produce an output in accordance with an illustrative embodiment;

FIG. 21 illustrates an XQuery expression that implements the data manipulation logic of a Transform operator instance in accordance with an illustrative embodiment;

FIG. 22 depicts a result feed from applying a Sort operator to a generic feed output in accordance with an illustrative embodiment;

FIG. 23 illustrates an XQuery expression that implements the data manipulation logic of a Sort operator instance in accordance with an illustrative embodiment;

FIG. 24 illustrates an XQuery expression that implements the data manipulation logic of a Union operator instance in accordance with an illustrative embodiment;

FIG. 25 depicts an exemplary operation of a data integration mechanism in accordance with an illustrative embodiment;

FIG. 26 depicts an exemplary import operation performed by the data integration mechanism in accordance with an illustrative embodiment;

FIG. 27 depicts an exemplary augment operation performed by the data integration mechanism in accordance with an illustrative embodiment;

FIG. 28 depicts an exemplary publish operation performed by the data integration mechanism in accordance with an illustrative embodiment;

FIG. 29 depicts an exemplary operation of an augmentation function that is a Filter operator in accordance with an illustrative embodiment;

FIG. 30 depicts an exemplary operation of an augmentation function that is a Merge operator in accordance with an illustrative embodiment;

FIG. 31 depicts an exemplary operation of an augmentation function that is a Annotate operator in accordance with an illustrative embodiment;

FIG. 32 depicts an exemplary operation of an augmentation function that is a Group operator in accordance with an illustrative embodiment;

FIG. 33 depicts an exemplary operation of an augmentation function that is a Transform operator in accordance with an illustrative embodiment;

FIG. 34 depicts an exemplary operation of an augmentation function that is a Sort operator in accordance with an illustrative embodiment; and

FIG. 35 depicts an exemplary operation of an augmentation function that is a Union operator in accordance with an illustrative embodiment.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, radio frequency (RF), etc.

Computer program code for carrying out operations of the present invention may be written in any combination of one or more programming languages, including an object oriented programming language such as Java™, Smalltalk™, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The illustrative embodiments are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The illustrative embodiments provide a mechanism for data integration that allows enterprise mashups (i.e. situational applications) to be built quickly and easily. The data integration mechanism performs data integration logic of an application, thereby allowing the enterprise mashup developer to focus on the application's business logic. In particular, the illustrative embodiments disclose a system for data integration that:
1. enables access to various types of data resources published by a variety of desktop, departmental, and Web sources both inside and outside the corporate firewall,
2. provides the capability to filter, standardize, join, aggregate, and otherwise integrate and augment the data resources retrieved from those sources, and
3. allows for the further transformation and delivery of the augmented data to Asynchronous JavaScript™ and XML (AJAX), Php: Hypertext Preprocessor (PHP), Ruby on Rails™, or other types of applications.

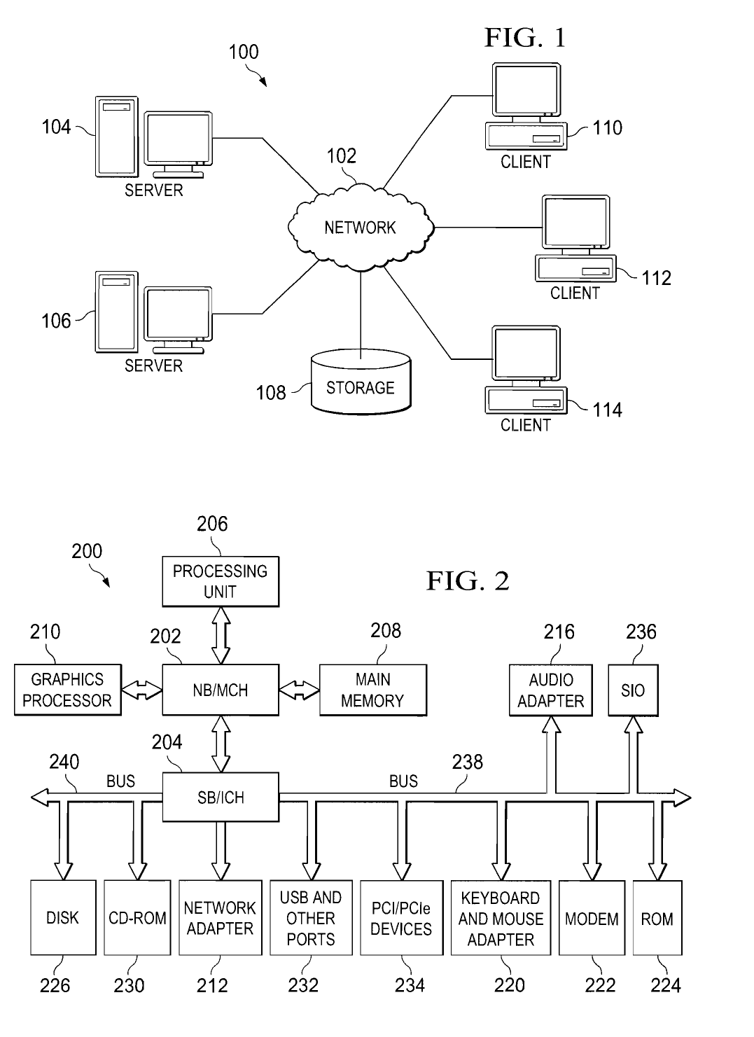

Thus, the illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as exemplary environments in which exemplary aspects of the illustrative embodiments may be implemented. While the description following FIGS. 1 and 2 will focus primarily on a single data processing device implementation of a data integration mechanism that allows enterprise mashups to be built quickly and easily, this is only exemplary and is not intended to state or imply any limitation with regard to the features of the present invention. To the contrary, the illustrative embodiments are intended to include distributed data processing environments and embodiments in which enterprise mashups are built quickly and easily.

With reference now to the figures and in particular with reference to FIGS. 1-2, exemplary diagrams of data processing environments are provided in which illustrative embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ System p® computer system, running the Advanced Interactive Executive (AIX®) operating system or the LINUX® operating system (eServer, System p, and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

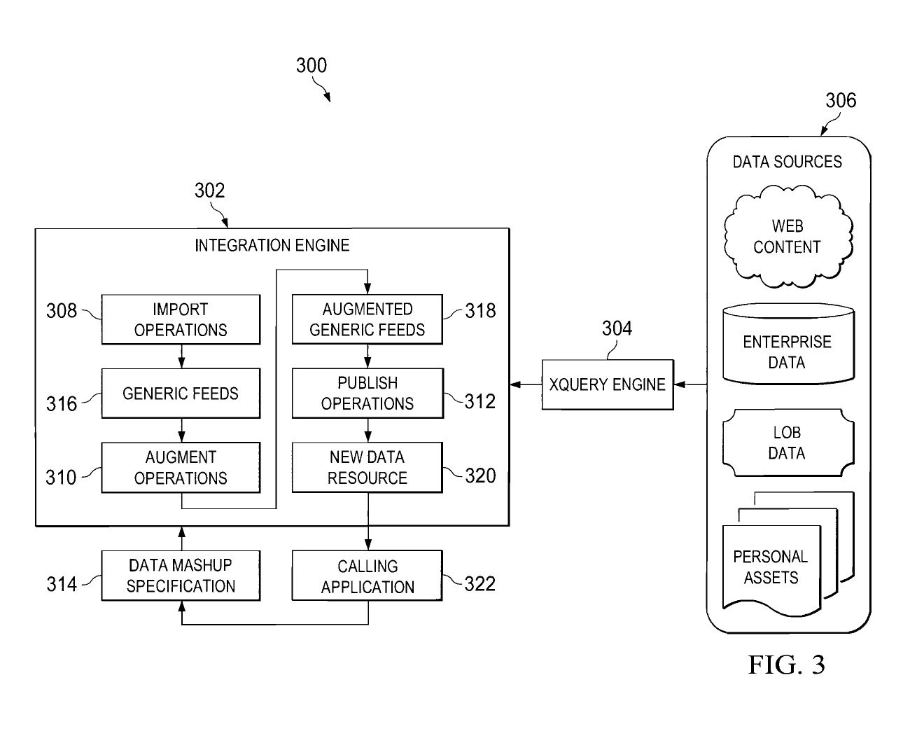

The mechanisms of the illustrative embodiments for data integration described herein integrate data resources using a process of generic feed augmentation. FIG. 3 depicts an exemplary data integration mechanism in accordance with an illustrative embodiment. Data integration mechanism 300 comprises integration engine 302, XQuery Engine 304 and one or more data sources 306. The process of data integration by generic feed augmentation involves execution of an interleaved sequence of import operations 308, augment operations 310, and publish operations 312 within integration engine 302 as defined by received data mashup specification 314. Import operations 308 retrieve a data resource from data source 306 and map the data resource into generic feeds 316. Generic feeds 316 may be comprised of an ordered set of payloads which represent an instance of some real world entities such as a stock quote, news article, customer order, or the like. Augment operations 310 may then filter, join, group, sort, or otherwise manipulate payloads of one or more of generic feeds 316 in order to produce augmented generic feeds 318. Publish operations 312 essentially performs the inverse of import operations 308, transforming one or more of augmented generic feeds 318 into new data resource 320, and making new data resource 320 available to the Web or other applications. Data resources 306 accessed and integrated by the data integration system may be of various data resource types such as extensible markup language (XML), Really Simple Syndication (RSS), Atom, JavaScript™ Object Notation (JSON), Comma-Separated Values (CSV), or other Multipurpose Internet Mail Extensions (MIME) types.

Import operations 308 typically retrieves a data resource from a data source via popular Web protocols such as Hypertext Transfer Protocol (HTTP), File Transfer Protocol (FTP), Simple Object Access Protocol (SOAP) or the like. Import operations 308 map a retrieved data resource into generic feeds 316 by:
1. retrieving the data resource from data source 306 into integration engine 302 using the specified protocol,
2. mapping the retrieved data resource to an XML representation using an ingestion function specific to the incoming data resource type, and
3. extracting XML fragments from the XML representation of the data resource and packaging them as the initial payload of generic feeds 316.

Augment operations 310 produces augmented generic feeds 318 by subsequently applying augment operations to generic feeds 316 produced by import operations 308. For example, a group augmentation operation partitions and aggregates the payloads of an input generic feed from generic feeds 316 according to specified grouping key. Augmented generic feeds 318 produced by the group augmentation operation has one new payload per distinct grouping key value, where each new payload represents the aggregation of all input payloads having the same grouping key value. Publish operations 312 transform one or more of augmented generic feeds 318 into new data resource 320 by calling an appropriate transformation function specific to the desired data resource type such as XML, RSS, Atom, JSON, CSV, HTML, or other MIME types.

Thus, a data mashup is a parameterized program of operators. Each operator corresponds to one of import operations 308, augment operations 310, or publish operations 312. Data integration mechanism 300 receives the data mashup and relevant parameter values in the form of data mashup specification 314 from calling application 322. Data integration mechanism 300 executes the operators of the data mashup specification and returns the integrated data resources produced by executing the data mashup as new data resource 320 to calling application 322.

In the preferred embodiment of the illustrative embodiments, a data mashup is represented as a data flow network of operators that interoperate in a demand-driven data flow fashion. The producer and consumer relationship between operators in the data flow network determines the sequence in which the import, augment, and publish operations of the data mashup are applied. Operators exchange data in the form of tuples. Each tuple may contain one or more named data objects. A data object represents either a generic feed, as might be produced by an operator representing an import or augment operation, or a data resource, as might be produced by an operator representing a publish operation.

A generic feed is represented by a sequence of nodes according to the XDM data model. Each node in a sequence representing a generic feed corresponds to a feed entry. The root node of the feed entry represents a container for the feed payload. Generic feeds 316 restrict the child nodes of a container node to element nodes; however, other nodes in the sub-tree rooted at the container node may be any XDM node. Child nodes of a container node correspond to the payload of the feed entry. In general, operators iterate over the container nodes of the sequence and perform filtering, joins, aggregation, and other set manipulations that involve the extraction and comparison of attribute and element values of the payload.

Data mashup operators may also have operands. Operands provide an operator with input parameters. A Uniform Resource Locator (URL) of a data resource is an example of an operand that might be provided to an operator representing an import operation. Operands may also be used to define an operator's relationship to other operators in the data mashup. For example, the operands to an operator representing a group augmentation operation would include the operator that produces the generic feed to be grouped and aggregated.

Operands may refer to variables. For example, a URL identifying a data resource that represents hotel reviews might receive the hotel name via a URL variable. A binding context provided to each operator provides the values of any variables the operator requires. The values of variables provided by the binding context might come either from parameters passed to the data mashup by the calling application, or from data imported into the data mashup via the execution of other operators. In one illustrative embodiment, a data mashup exchanges data with an application according to a REST protocol.

The main data processing logic of operators, such as a Merge operator, Filter operator, Annotate operator, Group operator, Transform operator, Sort operator, Union operator, or the like, in the illustrative embodiments may be implemented by evaluating XQuery expressions using XQuery engine 304 over the XDM sequences used to represent the generic feeds and data resources that are input to the operator. There are a variety of ways to implement XQuery engine 304 (e.g. DB2, Oracle, or the like) with bindings to popular programming languages (e.g. PHP, Java, or the like) that may be used by the data integration mechanism to evaluate such expressions. The specific XQuery expression(s) used by a particular operator instance to perform its data manipulation logic may be generated dynamically from a basic template and the operands passed to the operator.

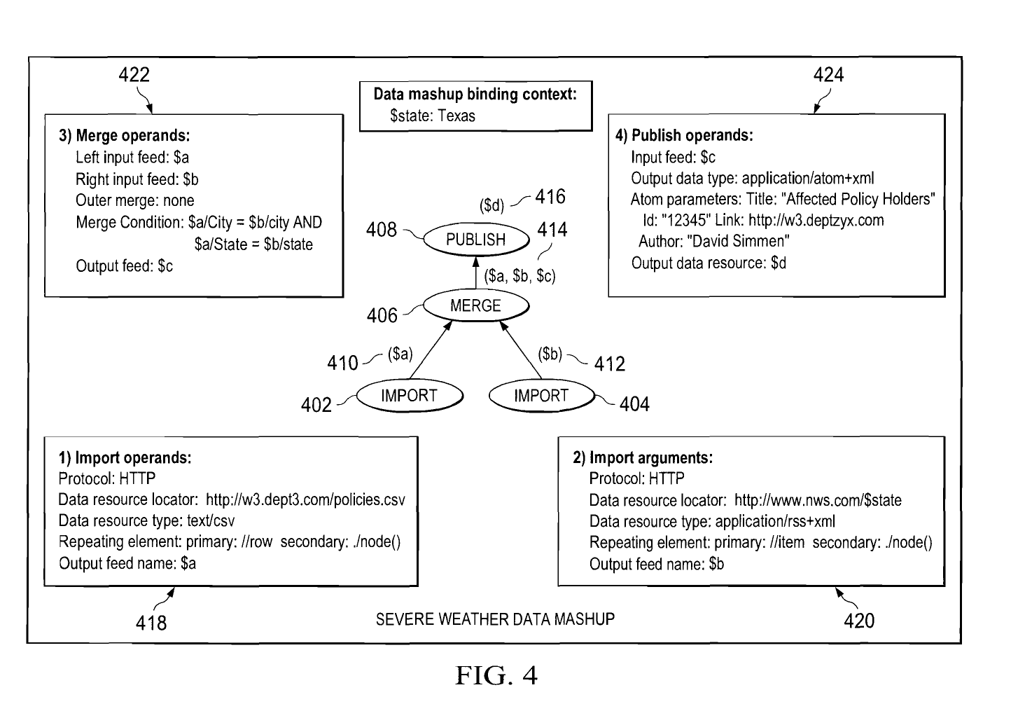

FIG. 4-19 depict examples of the operations performed by a data integration mechanism, such as data integration mechanism 300 of FIG. 3. While specific expressions, operator, operands, and the like are used in these examples, the present invention is not limited to such, as will be readily apparent to those of ordinary skill in the art upon reading the following description.

FIG. 4 depicts one exemplary data mashup in accordance with an illustrative embodiment. This example considers a scenario where a prudent insurance agent aims to create a data mashup that produces an Atom feed representing policy holders for a specified state that might potentially be affected by severe weather events in that state. Nodes 402, 404, 406, and 408 in graph 400 represent operators. Edges 410, 412, 414, and 416 represent a flow of tuples of data objects between the operators of nodes 402, 404, 406, and 408. Boxes 418, 420, 422, and 424 associated with the operators of nodes 402, 404, 406, and 408 describe an operator's operands.

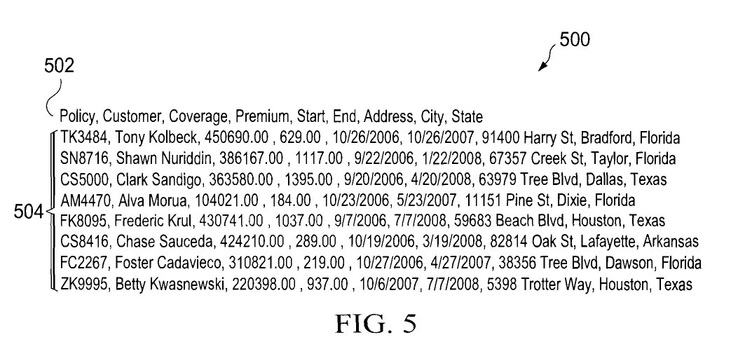

Import operators 402 and 404 are responsible for performing import operations. As shown in box 418, Import operator 402 imports a data resource containing policy holder data into a generic feed. The HTTP protocol (as specified by the “protocol” operand) may be used to retrieve the policy holder data from an intranet data source. The URL http://w3.dept3.com/policies.csv (as specified by the “data resource locator” operand) identifies the data resource. The data resource type may be a comma separated values (text/csv MIME type) file (as specified by the “data resource type” operand). An exemplary CSV representation 500 of policy holder data is shown in FIG. 5 in accordance with the illustrative embodiment. In FIG. 5, row 502 represents column values and rows 504 represent data values corresponding to each column value in row 502.

Returning to FIG. 4, Import operator 402 maps the CSV data resource into a generic feed by:
1. invoking an ingestion function that understands how to translate a CSV formatted data resource into an XML representation,
2. extracting XML fragments from this XML representation,
3. creating a feed entry and corresponding container node, and
4. inserting the XDM representation of each of the XML fragments into a separate container node. That is, each XML fragment extracted from the XML representation represents one payload. A single entry is formed by allocating a container node and then inserting elements and attributes in the XML fragment into the container node.

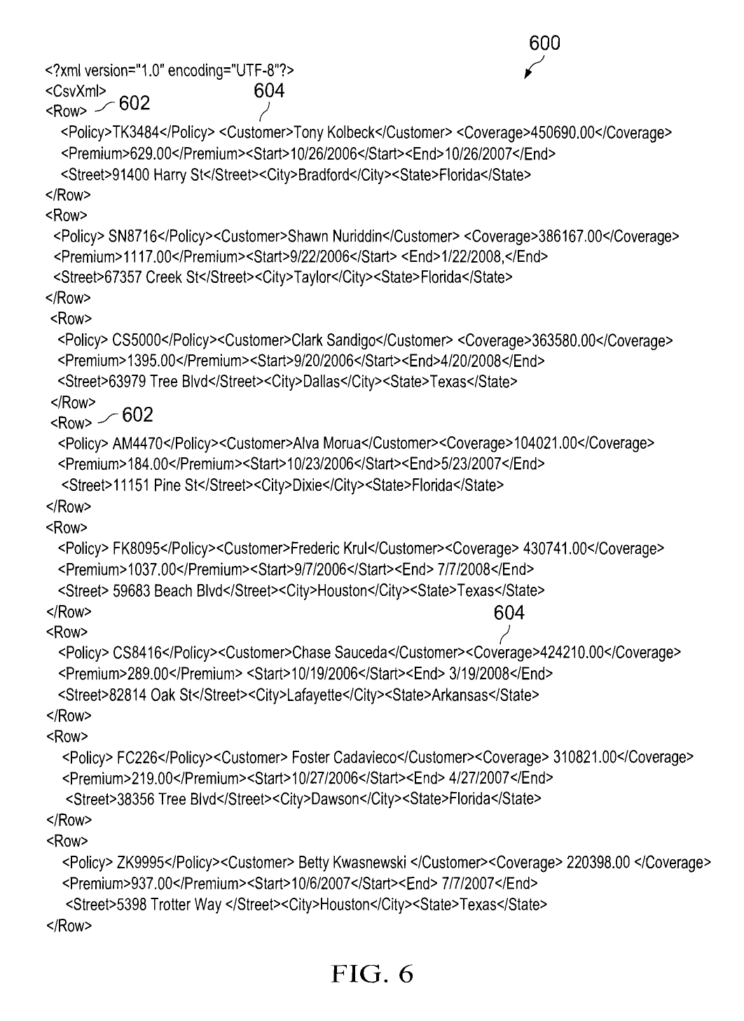

The output of one straightforward implementation of an ingestion function that maps CSV formatted data to an XML representation is illustrated in FIG. 6 in accordance with an illustrative embodiment. In CSV representation 600, each of rows 602 in the CSV resource corresponds to a “row” element in the XML representation. Child elements 604 of each row element in turn correspond to the column values of the corresponding row as specified in the CSV resource, such as column values 502 on FIG. 5. The name of each such child node is taken from the corresponding column name supplied in the header of the CSV data resource.

Returning to FIG. 4, the repeating element operand of Import operator 402 (specified by the “repeating element” operand) is defined by two xpath statements. The “primary xpath” statement identifies the list of nodes from which the payload is extracted. There is one entry in the generic feed per node extracted with the primary xpath statement. The optional “secondary xpath” statement is executed relative to each node extracted by the primary xpath statement. The “secondary xpath” identifies the elements and attributes under the primary node that will be inserted into the feed entry as payload. If either the primary or secondary xpath statements are not provided, they are assumed to be “./node( )”.

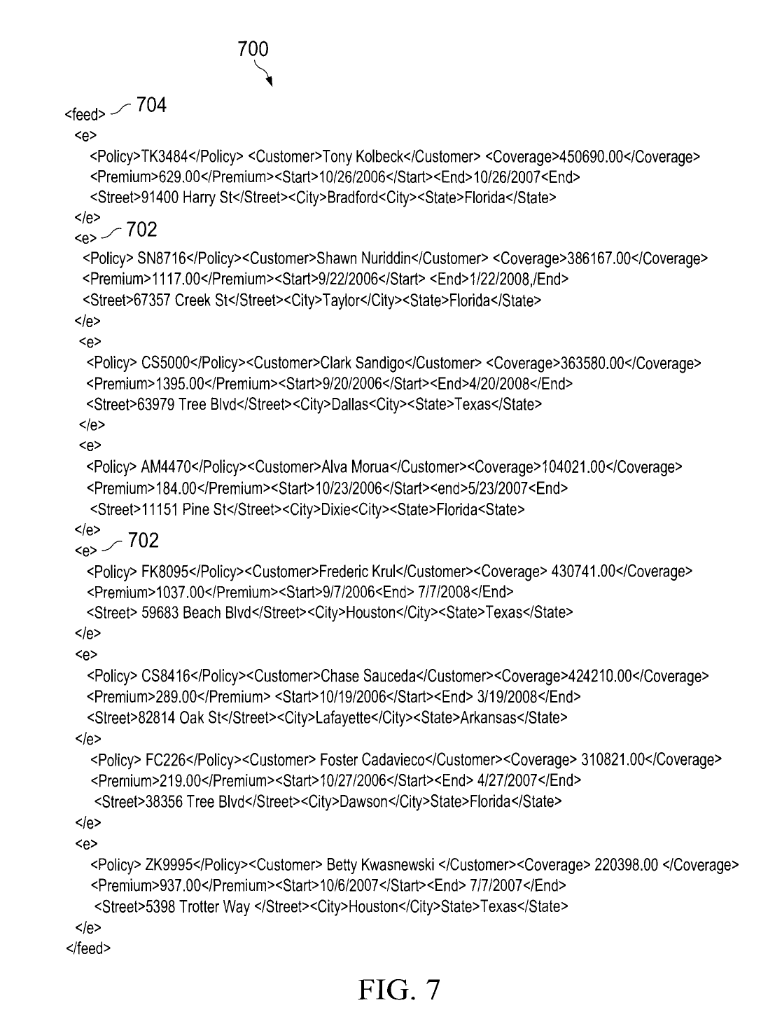

The primary xpath statement is given by “//row” in the example and so the payload is extracted from under each of the “row” elements. The secondary xpath statement is given by “./node( )” in the example and so the payload of each entry in the resultant generic feed contains all child elements of the corresponding row element. FIG. 7 illustrates final generic feed 700 of the CSV data resource representing policy holders in accordance with an illustrative embodiment. Note that special container nodes 702 of the generic feed are denoted by the element name “e”. “Feed” element 704 that is serving as the root node of all container nodes is only for illustrated purposes. “Feed element” 704 allows a generic feed to be displayed with a valid XML representation. (Internally, a generic feed might be implemented as an array of XDM nodes.)

Returning to FIG. 4, Import operator 402 associates the imported generic feed with the name “$a” (the name specified by the “output feed” operand), and adds the feed to output tuple 410, which flows to Merge operator 406 for further manipulation.

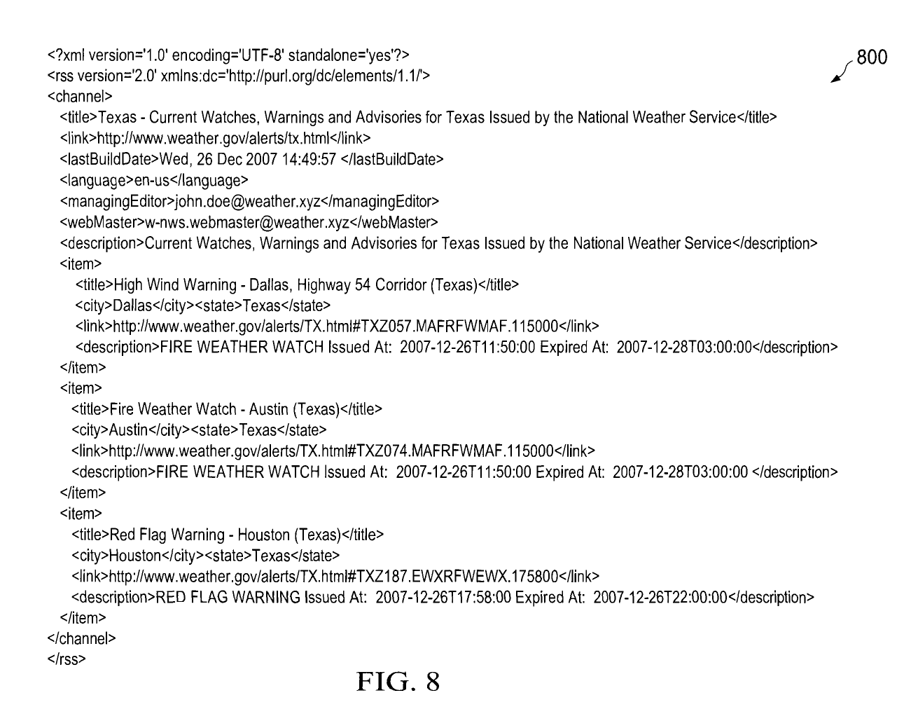

As shown in box 420, Import operator 404 maps a data resource representing severe weather data from a web data source into a generic feed. The severe weather events for a given state are made available via an RSS feed (data resource type application/rss+xml) at http://www.nws.com/$state (the data resource locator operand). Note that URL references the variable $state. (Variables are denoted with a $ in the first character). The value of the variable is provided to the Import operator via its binding context. The binding context provided to each operator is initialized with any input parameters passed to the data mashup when it is invoked. In the example, the value “Texas” is provided for $state (the box labeled “Data mashup binding context). Import operator 404 replaces the $state variable in the URL with the value “Texas” to form the URL http://www.nws.com/Texas which it then uses to retrieve the RSS feed data resource. FIG. 8 depicts RSS feed input 800 to Import operator 404 in accordance with an illustrative embodiment.

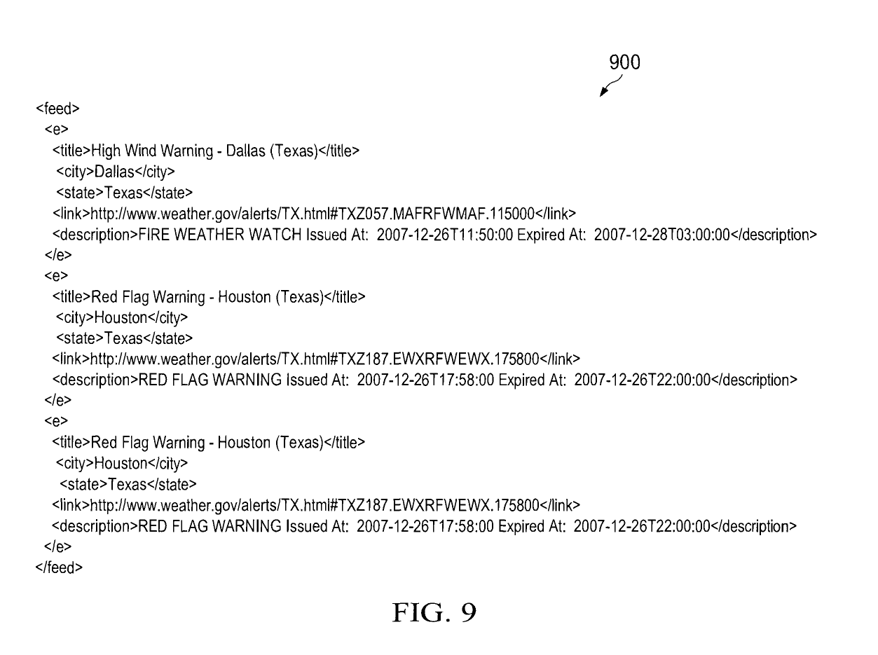

Returning to FIG. 4, since the RSS feed input, such as RSS feed input 800 of FIG. 8, is already in an XML format, Import operator 404 does not need to invoke an ingestion function. The payload of the corresponding generic feed entries is formed by first selecting all “item” elements of the RSS feed (the primary xpath statement of the repeating element operand) and then extracting all of the child elements of those elements to form the payload (the secondary xpath statement of the repeating element operand). The generic feed produced by Import operator 404 is associated with the name “$b” (the output feed operand) and added to output tuple 412 for further manipulation by Merge operator 406. FIG. 9 depicts generic feed output 900 that is output by Import operator 404 in accordance with an illustrative embodiment.

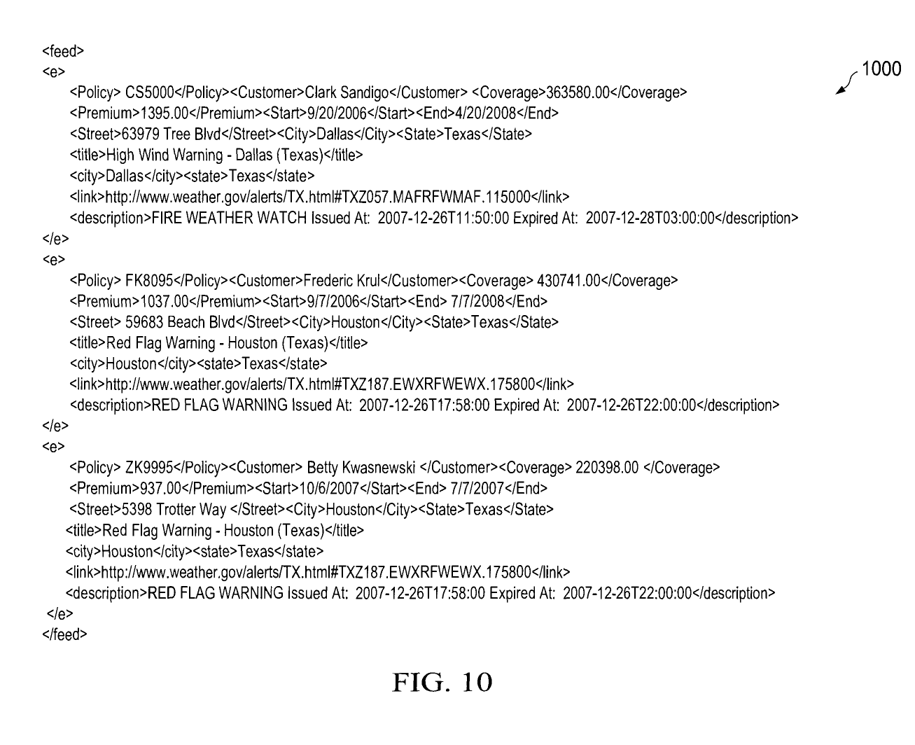

As shown in box 422, Merge operator 406 is one type of augment operator. Merge operator 406 produces a new generic feed by merging two input generic feeds according to a specified merge condition. In the example, Merge operator 406 merges the generic feeds produced by Import operators 402 and 404 (specified by the “left feed” and “right feed” operands, respectively) in order to produce a new generic feed whose entries represent policy holders affected by severe weather events. Merge operator 406 may be analogous to a relational join operator. Merge operator 406 forms the new feed by concatenating the payloads of the two input feeds that match according to the specified merge condition (provided by the “merge condition” operand). In the example, the payload of the output feed entries produced by Merge operator 406 is comprised of both policy holder payload and severe weather payload that match according to city and state. FIG. 10 illustrates merged output 1000 from Merge operator 406 for the input generic feed data produced by Import operators 102 and 404 as shown in FIGS. 7 and 9, respectively, in accordance with an illustrative embodiment.

Returning to FIG. 4, the generic feed produced by Merge operator 406 is associated with the name “$c” and is added to output tuple 408 that is passed to publish operator 408. Merge operator 406 may also perform outer merge operations (as specified by an “outer merge” operand). The outer merge may be analogous to a relational outer join operation. Besides the Merge augment operator, a Filter, Annotate, Group, Transform, Sort, and Union operators are examples of other powerful augment operators that may be used for manipulating instances of generic feeds.

As shown in box 424, Publish operator 408 is responsible for performing publish operations. In the example, Publish operator 408 transforms the generic feed produced by Merge operator 406 (as specified by the “input feed” operand) into an Atom formatted data resource (as specified by the “output data type” operand). In general, Publish operator 408 transforms a generic feed into a data resource by applying a transformation function specific to the desired output data resource type. Any arguments required by the transformation function are passed as operands to Publish operator 408. In the example, the transformation function that translates a augmented generic feed, such as augmented generic feed 1000 of FIG. 10, into an Atom feed requires basic information required to construct an Atom feed header (as specified by the “Title”, “Id”, “Link” and “Author” operands 1102).

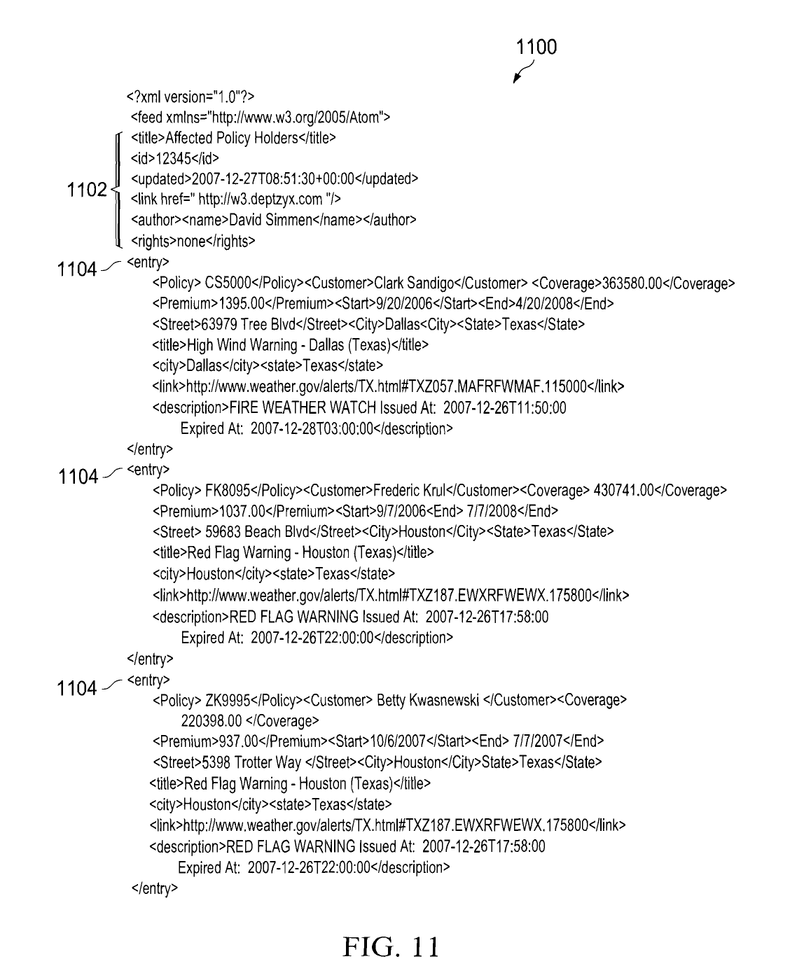

FIG. 11 depicts output 1100 from Publish operator 408 for the input generic feed shown in FIG. 10 in accordance with an illustrative embodiment. Output 1100 from Publish operator 408 shown in FIG. 11 is indicative of a straightforward implementation of a transformation function that maps a generic feed to an Atom formatted data resource. Each of the generic feed containers is replaced by a specific Atom “entry” element 1104. The Atom header is constructed using the transform function data provided via the corresponding Publish operands.

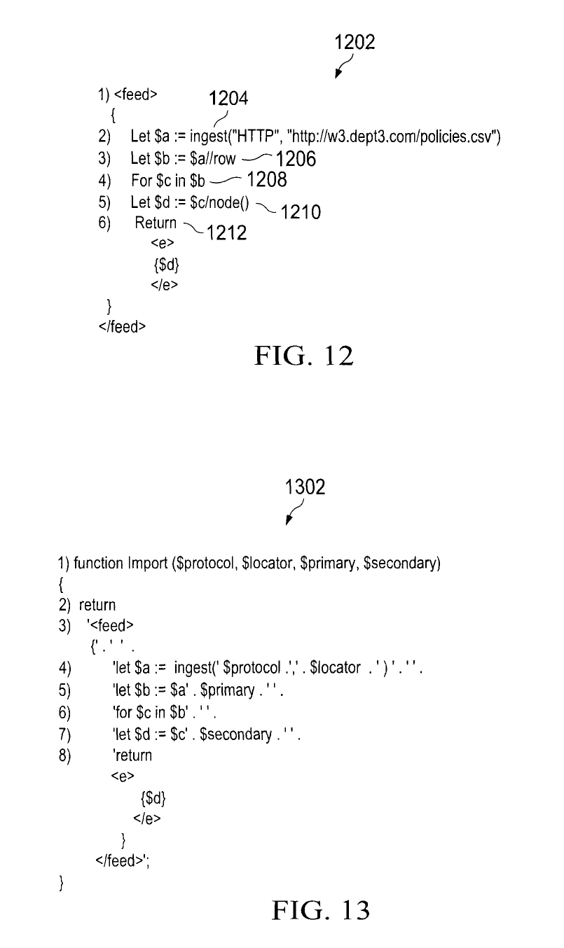

As aforementioned, the basic data manipulation logic of an operator is performed through the generation and evaluation of XQuery expressions by an XQuery engine, such as XQuery engine 304 of FIG. 3. FIG. 12 shows an exemplary XQuery expression 1202 that implements Import operator 402 of FIG. 4 in accordance with an illustrative embodiment. When evaluated, XQuery expression 1202 returns the generic feed of FIG. 7. “Ingest” function 1204 on line 2 performs the logic of importing the CSV file shown in FIG. 5 (given by the data resource locator “http://w3.dept3.com/policies.csv”) into the XML representation of that CSV file shown in FIG. 6. “Ingest” function 1204 may be analogous to the XQuery “doc” function in that it maps a data resource locator to a document node of the XDM data model. However, unlike the “doc” function, “ingest” function 1204 performs the additional step of invoking an appropriate ingestion function based on the MIME type of the retrieved data resource in order to map that data resource into an XML representation. On line 3 of FIG. 12, primary xpath statement “//row” 1206 of the repeating element operand is applied to the XML representation of the CSV resource in order to extract the list of “row” nodes that contain the feed payload. Each extracted node is then iterated by “for” clause 1208 on line 4. The secondary xpath statement “/node( )” 1210 of the repeating element operand is applied to each of the iterated nodes on line 5 in order to extract the feed payload. Finally, a new generic feed entry containing the extracted payload is then constructed by “return” clause 1212 on line 6. The specific XQuery expression that implements a specific instance of a data mashup operator is generated during operator initialization. The XQuery expression is generated using a basic template that is customized for the specific input operands to the operator.

FIG. 13 shows general PHP script 1302 for generating the XQuery expression that implements the data manipulation logic of an Import operator in accordance with an illustrative embodiment. PHP script 1302 takes a given protocol, data resource locator, primary xpath, and secondary xpath as arguments as shown on line 1. PHP script 1302 generates the XQuery expression of FIG. 12 when called with the input values “HTTP”, “http://w3.dept3.com/policies.csv”, “//row”, and “/node( )”. PHP script 1302 returns a string representing of an XQuery expression which may then be optimized and evaluated by an external XQuery engine (e.g. DB2 or Oracle). The XQuery string is generated by concatenating the substrings representing the operand values with a basic XQuery template. For example, the primary xpath of the repeating element operand is concatenated with the XQuery template on line 5.

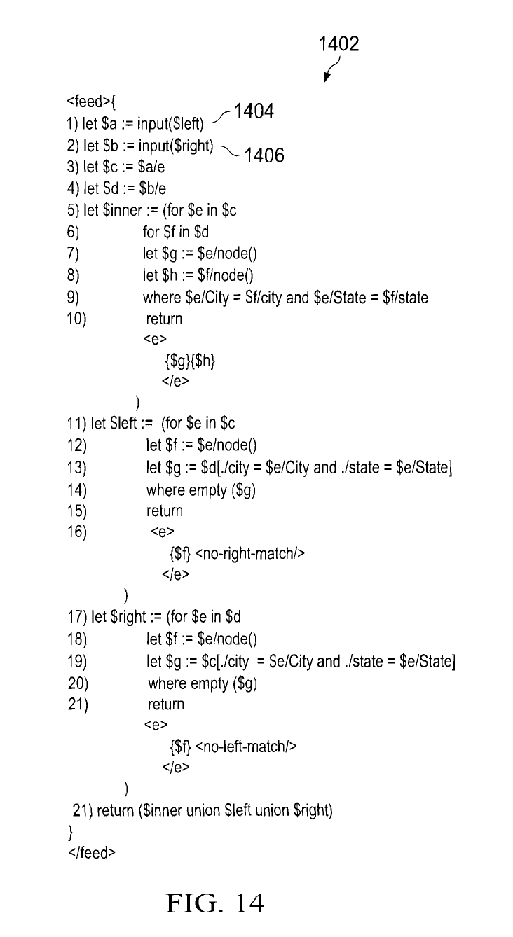

FIG. 14 provides an additional example of how an operator's data manipulation logic may be implemented using an XQuery expression in accordance with an illustrative embodiment. XQuery expression 1402 implements an instance of a Merge operator that performs a merge of a left feed operand “$left”, a right feed operator “$right”, with merge condition “$left/City=$right/city and $left/State=$right/state”, and an outer merge operand “full” (i.e. the XQuery returns not only the payloads of matching left and right feed entries, but also payloads of the left and right feed that have no match.) “Input” functions 1404 and 1406 referenced on lines 1 and 2 retrieve a specified feed from an input tuple and maps it into an instance of the XDM data model. The variables $a and $b hold the retrieved XDM instances of the left and right feed respectively. The feed entries are then extracted into XDM sequences on lines 3 ($c) and 4 ($d). The XQuery For-Let-Where-Return (FLWR) sub-expressions that assign to the variables “$inner” (line 5), “$left” (line 11), and “right” (line 17) are performing the logic that finds matching entries that finds left feed entries that have no match, and right feed entries that have no match, respectively.

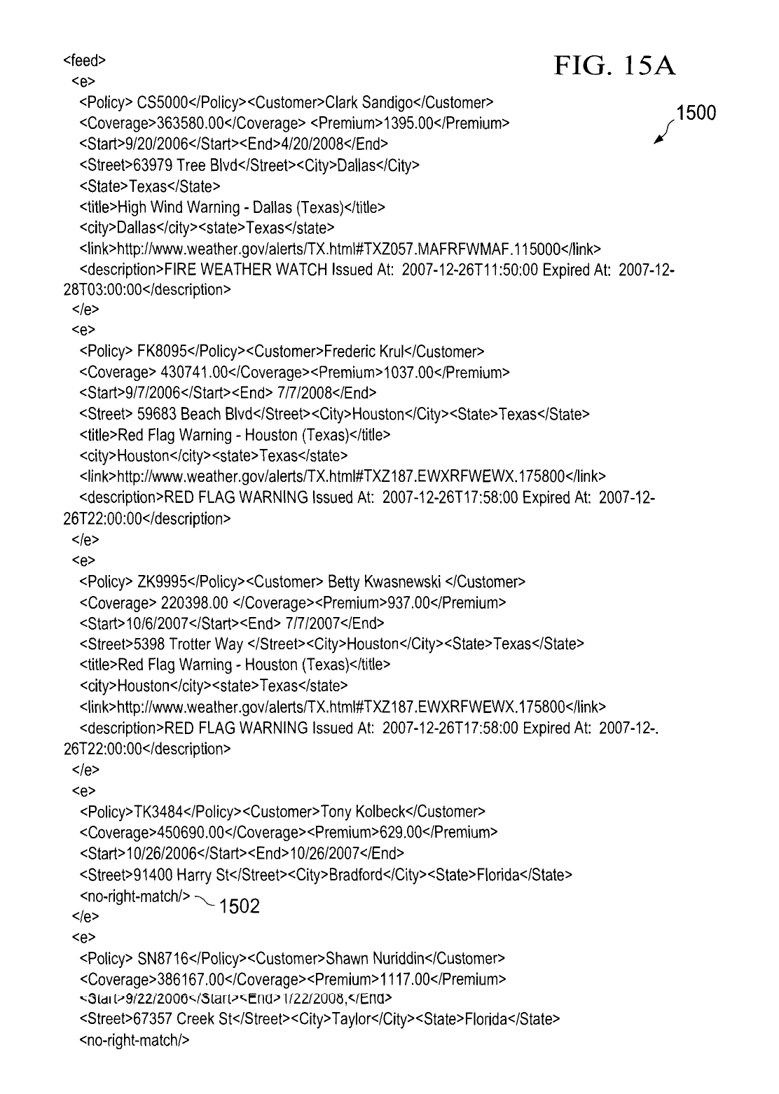

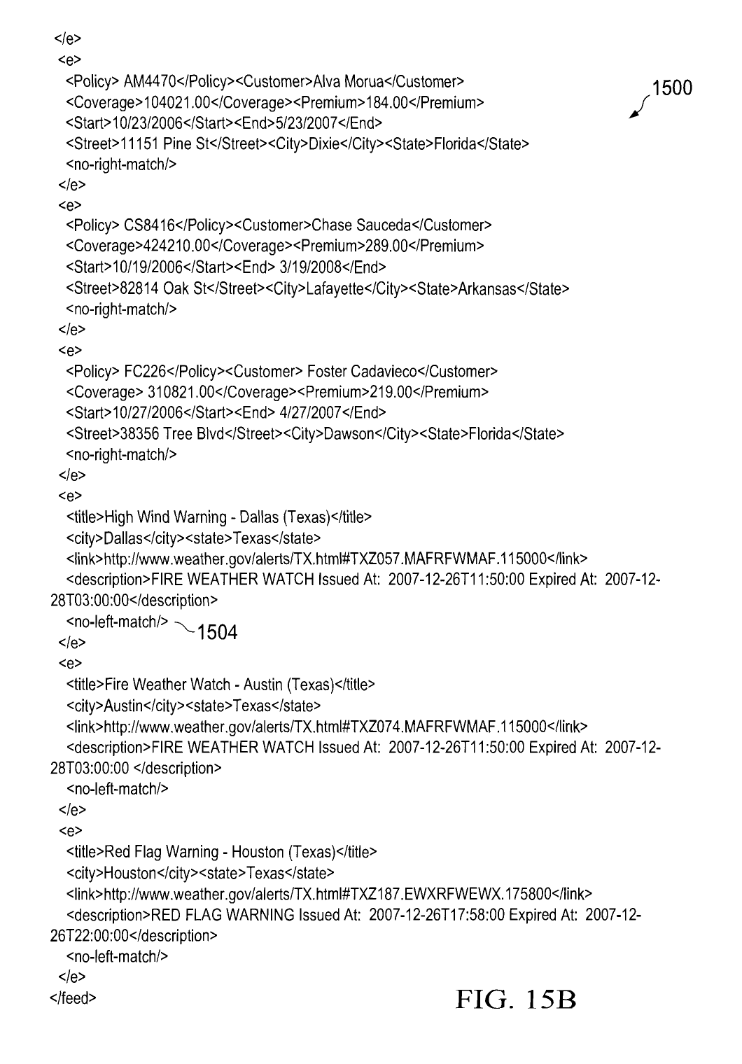

FIGS. 15A and 15B shows exemplary output 1500 of the XQuery expression given the generic feed of FIG. 7 as the “$left” input and the generic feed of FIG. 9 as the “$right” input in accordance with an illustrative embodiment. Note that the entries of the output having the payload element “no-right-match” 1502 correspond to the left input feed entries that have no match in the right input feed (generated on line 16 of FIG. 14). Further, the output feed entries with the payload element “no-left-match” 1504 correspond to the right input feed entries that have no match in the left input feed (generated on line 21 of FIG. 14).

In the preferred embodiment of the invention, REST interfaces (i.e. XML over HTTP) are provided for defining a data mashup and for retrieving the result. The data mashup may be described to the data integration system by an XML document. Elements and attributes of the XML representation of the data mashup are understood by the data integration system as data mashup operators and operands. When the data integration system receives the data mashup, the data integration system performs basic processing of the data mashup and returns a URL that can be invoked by an application in order to retrieve the data mashup result. Parameters to the data mashup are provided to the application via typical mechanisms, such as GET or POST mechanisms of the HTTP protocol.

As previously discussed, there are many operators that may be used by the data integration mechanism of the illustrative embodiments. The following is a detailed description of some exemplary data mashups operators according to the illustrative embodiment, although many modifications to the depicted environments may be made without departing from the spirit and scope of the present invention.

An Import operator performs an import operation by retrieving a data resource from a data source and mapping it to a generic feed. The Import operator uses a protocol, data resource locator, repeating element specification, and binding context as operands. The previous detailed discussion of FIG. 4, FIG. 12, and FIG. 13 illustrates the workings of the Import operator according to the illustrative embodiments.

A Publish operator performs a publish operation by transforming a generic feed into a data resource of a specified data type. The Publish operation uses an input feed, binding context, output data type, transformation function, and transformation function arguments, as operands. The Publish operator invokes the transformation function with transformation function arguments on the input generic feed to produce a data object of the specified output data type. The output data type may be one of the MIME types for which a transformation function exists. The Publish operator then serializes (forms a string representation of) the data object, producing a data resource. The previous discussion of FIG. 4 illustrated the workings of the Publish operator by showing the transformation of a generic feed (FIG. 10) into a data resource of MIME type application/atom+xml (FIG. 11).

A Merge operator performs an augment operation by concatenating the payloads of two different input feeds that match according to a specified merge condition. The Merge operator may also return entries in either input feed that have no corresponding match in the other feed. The Merge operator uses as operands a “left feed”, “a right feed”, a “merge condition”, and an “outer merge specification”. The previous detailed discussion of FIG. 4, FIG. 14, and FIG. 15 above illustrated the workings of the Merge operator according to the illustrative embodiment. Note that alternate result feed constructions are possible. For example, a feed construction may be created where one result left (right) feed entry contains all matching right (left) feed entries as payload.

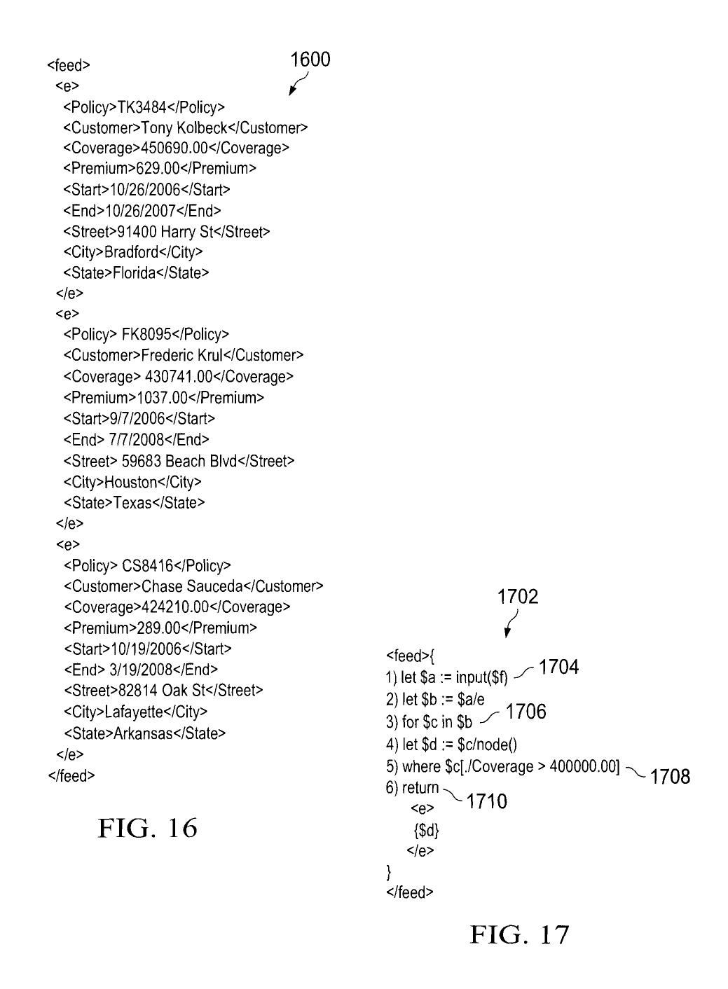

A Filter operator performs an augment operation by effectively removing entries from an input feed that fail to satisfy a specified filter condition. The Filter operator uses an input feed and a filter condition as operands. FIG. 16 depicts output 1600 of a Filter operator that applies the filter condition “./Coverage>400000.00” to generic feed 700 of FIG. 7 in accordance with an illustrative embodiment. FIG. 17 depicts XQuery expression 1702 that implements the data manipulation logic of such a Filter operator in accordance with an illustrative embodiment. Input feed 1704 designated by the variable $f is retrieved into an XDM instance $a on line 1. Input feed entries are extracted into $b on line 2. Each feed entry is iterated by “for” clause 1706 into $c on line 3. Payload is extracted on line 4. The filter condition is effectively applied by “where” clause 1708 on line 5. Finally, on line 6, “return” clause 1710 constructs result feed entries using the payload of input feed entries that satisfied the filter condition.

An Annotate operator performs an augmentation operation by combining each entry of an input feed with all entries of an “annotation feed” that is produced in the context of a given input feed entry. The Annotate operator uses an input feed, a binding context, an annotation operator, and an outer context specification as operands. The Annotate operator passed to the augment operations may be any type of operator, such as an Import operator, Filter operator, Merge operator, Sort operator, Union operator, Group operator, Publish operator, another Annotate operator, or the like. The outer context specification is used to derive an outer context from a given feed entry. An outer context is essentially a set of variable name-variable value associations and is essentially a binding context that is formed anew for each entry of the input feed. An outer context specification is a set of variable name-expression associations that is used to derive the outer context for each feed entry. A given outer context member is formed by applying the expression to each entry. The result of applying the expression to each entry (i.e. a sequence) is then associated with the associated variable name. For example, if an outer context specification associates variable “$hotel” with expression “./hotel/name/text( )”, variable “$city” with expression “./hotel/city/text( )”, and variable “$state” with expression “/hotel/state/text( )” then the outer context derived from the entry

<e>

<hotel>

<name>Palace Hotel</name>
<city>San Francisco</city>
<state>CA</state>

</hotel>

</e>

would contain the associations “$hotel” with “Palace Hotel”, “$city” with “San Francisco”, and “$state” with “CA”.

The annotation operator operand is evaluated anew for each entry using a binding context formed by combining the outer context derived from each entry with the input binding context. For example, the operation may get the next entry, form an outer context and new binding context, evaluate the operator, and repeat. Each evaluation of the annotation operator operand produces a new augmented feed. Variable names specified in the outer context specification are typically variables referenced by operands of the annotation operator or by operands of the operators contributing to the production of input feeds to the annotation operator; hence, the annotation operator essentially behaves like a function whose result depends upon values in the input feed entries.

For example, an input feed entry may contain information for an IBM approved hotel, and the annotation operator may be an Import operator that retrieves hotel reviews from a web service that requires a hotel name, city, and state as input. In general, the annotation operator creates one new entry in the result feed for each entry in the annotation feed returned by evaluating the annotation operator. The payload of a new entry in the result feed is formed by concatenating the payload of the input feed entry and the payload of the entry in the annotation field. Continuing the example, the payload of a given result feed entry would contain information about an IBM approved hotel and a single review for that hotel. Thus, there would be one entry in the result feed per IBM hotel and review combination. The default construction is similar to that shown for the Merge operator, which also merges entries of two feeds. Note that alternate result feed constructions are possible. For example, each result feed entry might contain the payload of all corresponding annotation feed entries.

A Group operator performs an augment operation by grouping the entries of an input feed according to the values of specified grouping expressions; thereby, producing one result feed entry per group. The payload of each result feed entry combines the payload of all entries of the input feed that are in the same group. The Group operator uses an input feed, group expressions, and nest expressions as operands. The group operator:
1. iterates over each input feed entry,
2. forms a grouping key by applying the specified grouping expressions to each input feed entry,
3. identifies the result feed entry corresponding to grouping key; creating one if necessary, and
4. applies the nest expressions to the input feed entry to extract nest expression values which are then added to the payload of the result feed entry.

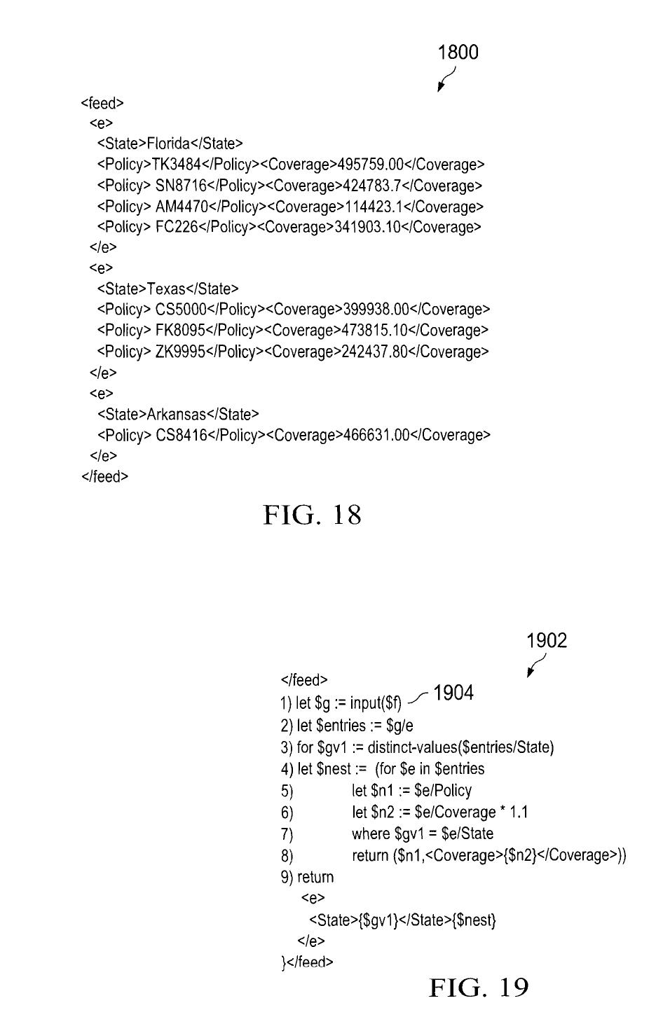

FIG. 18 depicts output 1800 of applying a Group operator with group expression “./State” and nest expressions “./Policy”, and “./Coverage*1.1” to the feed of FIG. 7 in accordance with an illustrative embodiment. The result feed contains three entries, one for each of the “State” element values “Arkansas”, “Florida”, and “Texas”. Each result feed entry contains the policy numbers and coverage information for all policy holders in the corresponding state (with the coverage bumped up by 10% perhaps in preparation for some “what if” analysis) as specified by nest expressions.

FIG. 19 illustrates XQuery expression 1902 that implements the data manipulation logic of a Group operator instance in accordance with an illustrative embodiment. Input feed $f 1904 is retrieved from an input tuple and mapped into an XDM instance $g on line 1. Entries are extracted from the input feed into $entries on line 2. The set of distinct “State” element values are extracted and iterated into $gvl on line 3. These values are the set of group key values of the input feed. The XQuery FLWR expression on lines 4 through 8 computes all nest expression values for a given group value. Each input feed entry is iterated and compared to the current group value $gvl using the where clause on line 7. The variables assignments $n1 and $n2 on lines 5 and 6 extract the nest expression values from the input feed entry $e. A result feed entry comprised of the current group key value and all nest expression values for that group is constructed on line 9.

Although not illustrated in XQuery expression 1902, a Group operator may receive multiple group expressions. In such cases, input feed entries are grouped according to the combination of values extracted by applying each of the group expressions. Note that the result of each group or nest expression can be a sequence containing more than one item; therefore, there is not a 1-1 correspondence between the number of group expressions and the number of values in the group key. Nor is there a correspondence between the number of nest expressions and the number of nest expressions values. In such cases, the group key and nest key values are formed by combining all values extracted through application of the group or nest expressions. Note that alternate result feed constructions are possible. For example, one might add elements or attributes to the result feed in order to delineate the group key values and/or the nest expression values for a group.

A Transform operator performs an augment operation by reconstructing the payload of each input feed entry. The Transform operator uses an input feed, a transformation context specification, and a payload template, as operands. The transformation context specification is similar to an outer context specification used by an Annotate operator in that it specifies a set of variable-expression associations that are used to form a transformation context, which is a set of variable-value associations computed from each input feed entry. The values of variables in a given transformation context can be substituted for variables referenced in the received payload template. The transform operator produces a result feed as follows:
1. iterates over each input feed entry,
2. forms a transformation context for the entry by applying the specified expressions in the transformation context specification,
3. computes an instantiated payload template by copying the received payload template operand and then substituting each variable reference in the copied payload template with the corresponding variable value in the transformation context, and
4. creates a new entry in the result feed whose payload is the instantiated payload template.

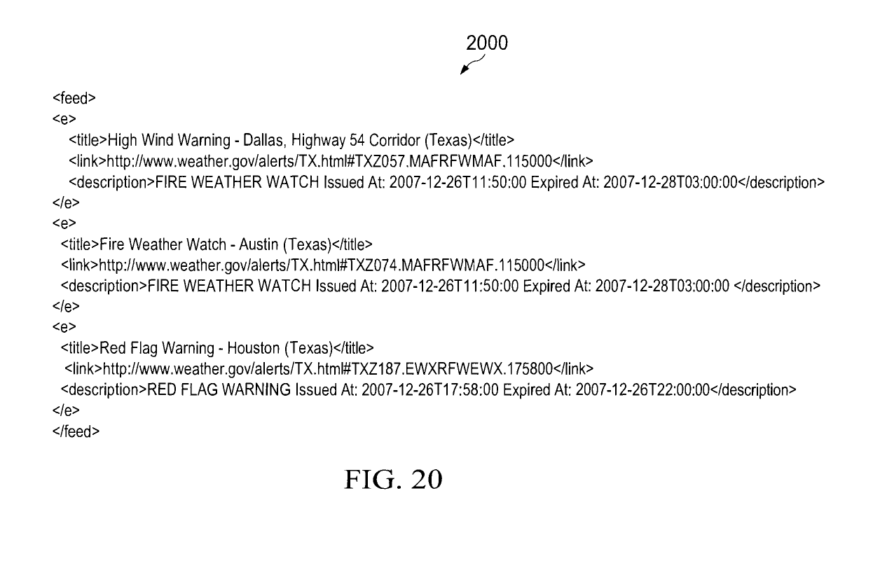

FIG. 20 depicts input feed 2000 for a Transform operator which may be used to produce an output, such as generic feed output 900 in FIG. 9, in accordance with an illustrative embodiment. The Transform operator producing that result feed receives a transformation context specification operand which has the variable-expression associations: $title and ./title, $link and ./link, $description and ./description, $cityText and regexp(“\-\s(.*)\s\((.*)\)”,$title), and $stateText and regexp(“\-\s(.*)\s\((.*)\)”,$title), (2) the following payload template operand

<e>

$title,
<city>$cityText </city>,
<state> $stateText</state>,
$link ,
$description,

</e>

A transformation context is formed for each entry in input feed 2000 by applying the expressions in the transformation context specification to an entry of input feed 2000. An entry in the new feed is then formed by substituting those values into a copy of the payload template. For example, the transformation context computed for the first entry of input feed 2000 would contain the variable-value associations: $title and “High Wind Warning—Dallas, Highway 54 Corridor (Texas)”, $link and “http://www.weather.gov/alerts/TX.html#TXZ057.MAFRFWMAF. 115000”, $description and “FIRE WEATHER WATCH Issued At: 2007-12-26T11:50:00 Expired At: 2007-12-28T03:00:00”, $cityText and “Dallas”, $stateText and “Texas” (the regexp functions extract substrings from strings using regular expression patterns—similar to the regexp functions available in the xpath or java languages). The payload of the first entry in the result feed is formed from this transformation context by substituting its variable values for the corresponding variables referenced in the payload template.

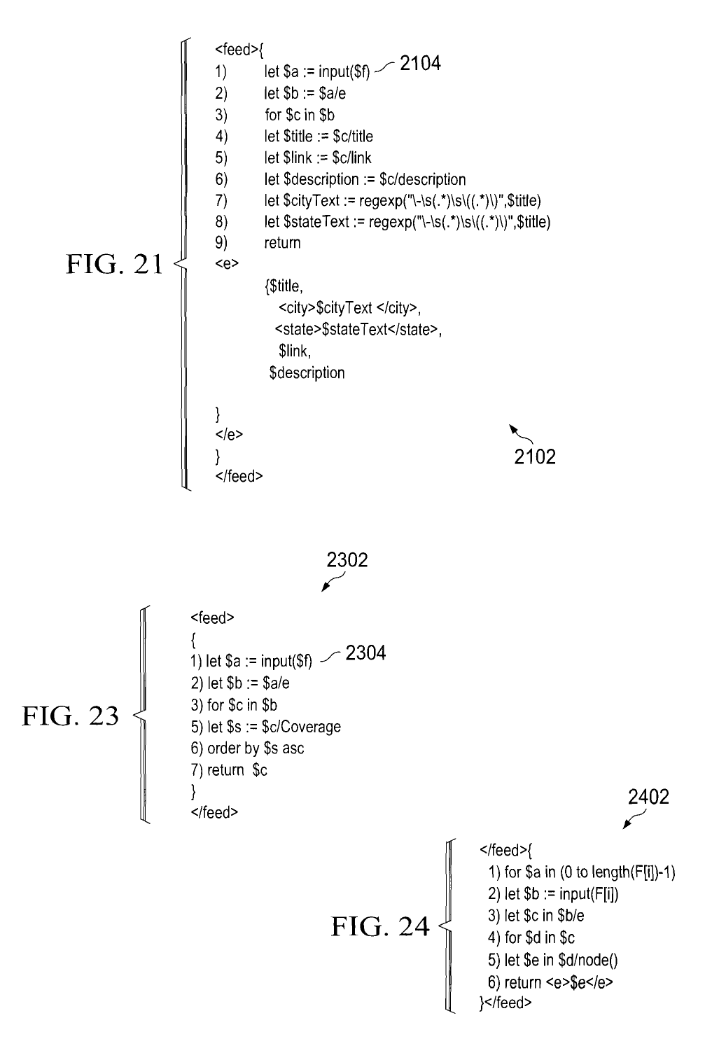

FIG. 21 illustrates XQuery expression 2102 that implements the data manipulation logic of a Transform operator instance in accordance with an illustrative embodiment. Input feed $f 2104 is retrieved from an input tuple and mapped into XDM instance $a on line 1. Feed entries are then extracted into $b (line 2) and iterated into $c (line 3). The transformation context for $c is then formed by applying those expressions (lines 4-8). In effect, the transformation context corresponds to the values contained in the Xquery binding tuple formed by applying those transformation context specification expressions. The instantiated payload template is then formed by substituting values from the binding tuple into the Xquery return clause template (line 9).

A Sort operator performs an augment operation by ordering the entries of an input feed. The Sort operator uses an input feed and a sort key specification, as operands. A sort key specification is used to form a sort key for each input feed entry. Each entry is then added to the result feed in the appropriate relative location according to the sort key. The sort key specification contains a set of associated sort expression-ordering attribute pairs. Each sort expression is used to extract a component value of the sort key while the associated ordering attribute determines how result entries are ordered relative to that value.

The Sort operator:
1. iterates over each input feed entry,
2. forms a sort key using the sort key specification, and
3. inserts a copy of the input feed entry into the result feed in the appropriate place relative to other entries according to the sort key.

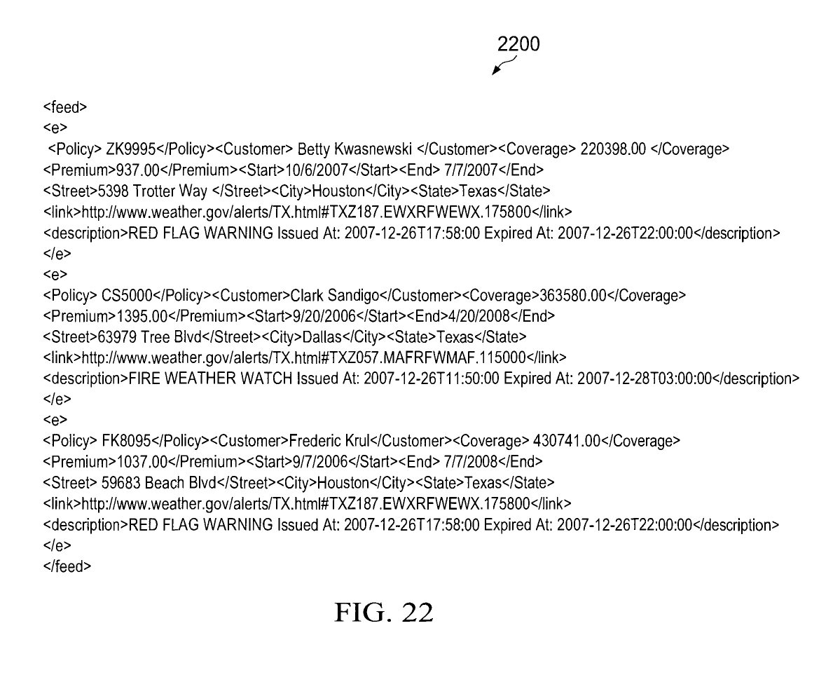

FIG. 22 depicts result feed 2200 applying a Sort operator to the generic feed output 900 in FIG. 9 in accordance with an illustrative embodiment. The Sort operator producing result feed 2200 receives the sort key specification associations “./Coverage” and ordering attribute “ascending”. FIG. 23 illustrates XQuery expression 2302 that implements the data manipulation logic of a Sort operator instance in accordance with an illustrative embodiment. Input feed $f 2304 is retrieved from an input tuple and mapped into XDM instance $a on line 1. Feed entries are then extracted into $b (line 2) and iterated into $c (line 3). The sort key component values are then formed by applying the sort key expressions (lines 5). Finally, the order by clause (line 6) orders the result entry according to the computed sort key component value and the associated ascending ordering attribute.

A Union operator performs an augment operation by creating a new feed that contains a copy of each entry in an array of input feeds. The Union operator uses an array of input feeds F[ ], as operands. The Union operator iterates over each input feed F[i] in F and appends a copy of each entry E in F[i] to the result generic feed. FIG. 24 illustrates XQuery expression 2402 that implements the data manipulation logic of a Union operator instance in accordance with an illustrative embodiment. The Xquery successively iterates array indexes into $a on (line 1). It then retrieves the next input feed F[i] from the input tuple into XDM instance $b using the next array index. Entries of feed F[i] are then extracted into $c (line 3) and iterated into $d (line 5). The payload of $d is then extracted into $e (line 5). Finally, a new entry of the result feed is constructed by the return clause using $e (line 6).

Thus, the mechanisms for data integration integrate data resources using a process of generic feed augmentation. The process of data integration by generic feed augmentation involves execution of an interleaved sequence of import operations, augment operations, and publish operations as defined by a received data mashup specification. An import operation retrieves a data resource from data source and maps the data resource into a generic feed. A generic feed may be comprised of an ordered set of payloads which represent an instance of some real world entities such as a stock quote, news article, or customer order. Augment operations may then filter, join, group, sort, or otherwise manipulate payloads of one or more generic feeds in order to produce augmented generic feeds. A publish operation essentially performs the inverse of an import operation, transforming a generic feed into a new data resource, and making the new data resource available to Web or other applications.

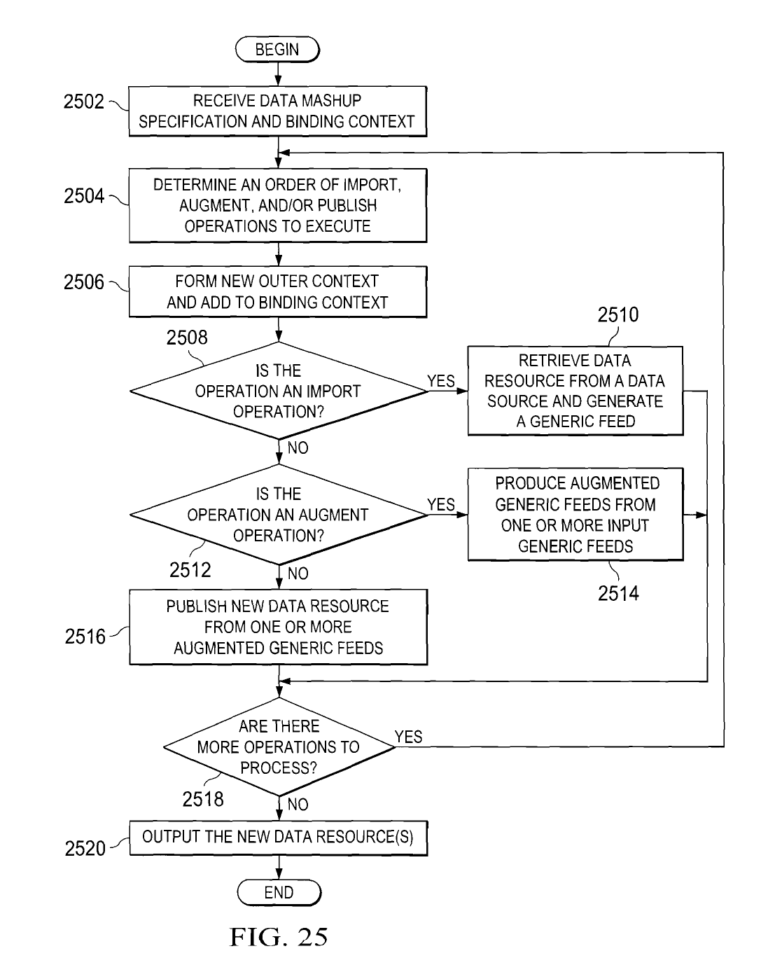

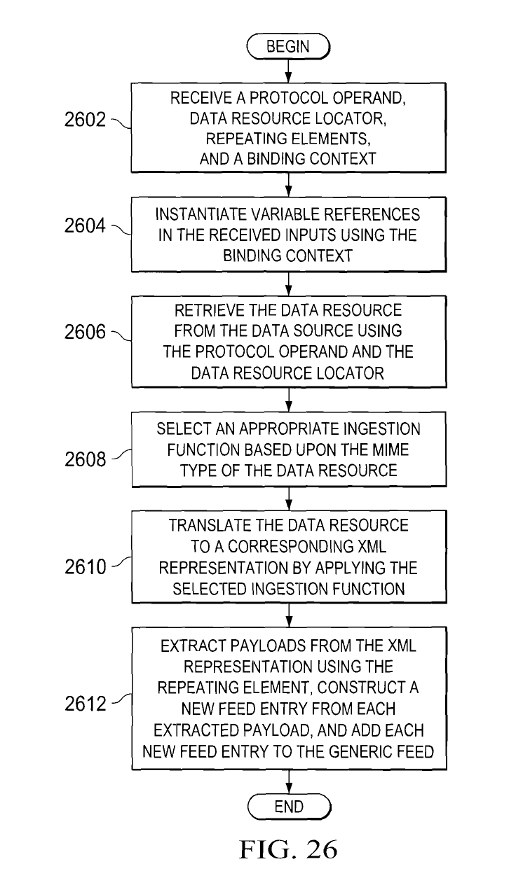

FIG. 25 depicts an exemplary operation of a data integration mechanism in accordance with an illustrative embodiment. As the operation begins, the data integration mechanism receives a data mashup specification and binding context (step 2502). The data integration mechanism determines an order of import operations, augment operations, and publish operations that are to be executed in the data mashup (step 2504). The data integration mechanism then forms a new outer context for the operations and adds the outer context to the binding context (step 2506). The data integration mechanism then determines if the current operation is an import operation (step 2508). If at step 2508 the operation is an import operation, then the data integration mechanism retrieves the data resource from the data source and generates a generic feed (step 2510), with the operation proceeding to step 2518 thereafter. A detailed description of step 2510 is described in FIG. 26 that follows.

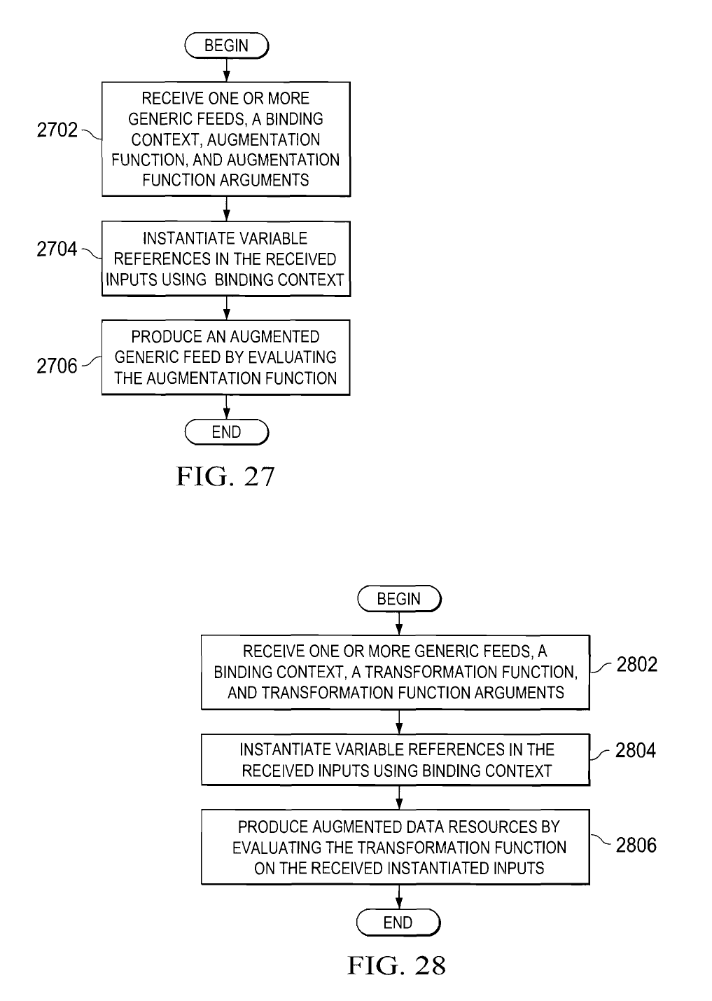

If at step 2508 the operation is not an import operation, then the data integration mechanism determines if the operation is an augment operation (step 2512). If at step 2512 the operation is an augment operation, then the data integration mechanism produces an augmented generic feed from one or more of the generic feeds generated by an import operation (step 2514), with the operation proceeding to step 2518 thereafter. A detailed description of step 2514 is described in FIG. 27 that follows. If at step 2512 the operation is not an augment operation, then the data integration mechanism identifies the operation as a publish operation and the data integration mechanism publishes a new data resource from one or more of the augmented generic feeds (step 2516), with the operation proceeding to step 2518 thereafter. A detailed description of step 2516 is described in FIG. 28 that follows.

From steps 2510, 2514, and 2516, after either an import operation, an augment operation, or a publish operation has completed, the data integration mechanism determines if there are any more operations associated with the data mashup that need to be processed (step 2518). If at step 2518 there are more operations to be processed, the operation returns to step 2504. If at step 2518 there are no more operations to be processed, then the data integration mechanism outputs the new data resource(s) (step 2520), with the operation ending thereafter.

FIG. 26 depicts an exemplary import operation performed by the data integration mechanism at step 2510 of FIG. 25 in accordance with an illustrative embodiment. As the operation begins, the data integration mechanism receives a protocol, a data resource locator, repeating elements, and a binding context for the operation that is to be processed (step 2602). The data integration mechanism instantiates any variable references in the received inputs using the binding context (step 2604). The data integration mechanism uses the protocol and the data resource locator to retrieve the data resource from the data source (step 2606). In order to import data resource, the data integration mechanism selects an appropriate ingestion function based on the MIME type of the data resource (step 2608). The data integration mechanism then translates the data resource into an XML representation by applying the ingestion function (step 2610). Then the data integration mechanism extracts payloads from the XML representation using the repeating element, constructs a new feed entry from each extracted payload, and adds each new feed entry to the generic feed (step 2612), with the operation ending thereafter.

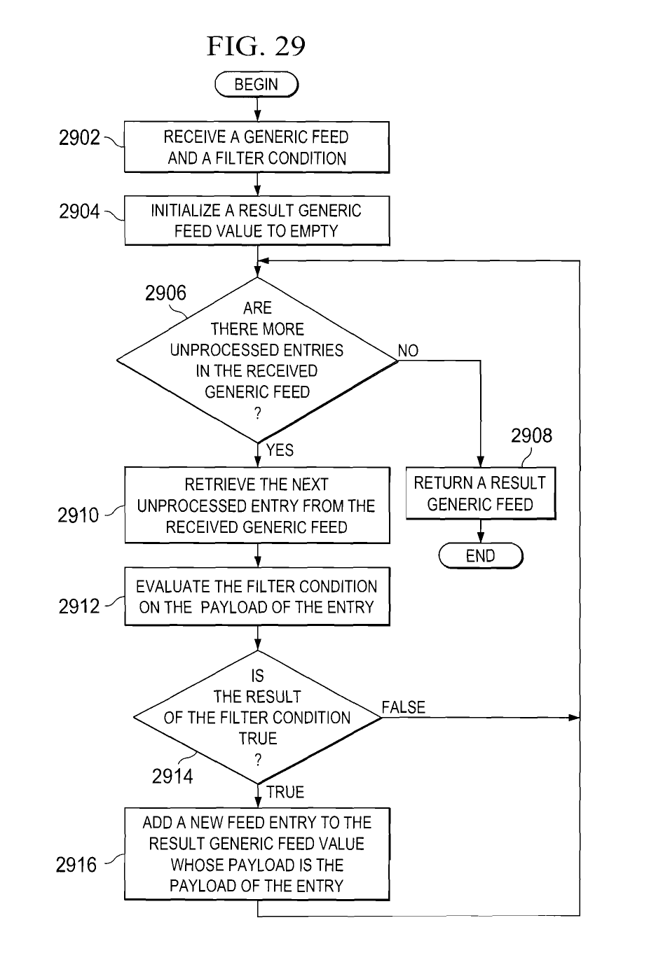

FIG. 27 depicts an exemplary augment operation performed by the data integration mechanism at step 2514 of FIG. 25 in accordance with an illustrative embodiment. As the operation begins, the data integration mechanism receives one or more generic feeds produced by an import or some other augment operation of the data integration mechanism, a binding context, an augmentation function, and augmentation function arguments (step 2702). The data integration mechanism instantiates any variable references in the received inputs using the binding context (step 2704). Then the data integration mechanism produces an augmented generic feed by evaluating the augmentation function (step 2706), with the operation ending thereafter. The augmentation functions may be a Filter operation, Merge operation, Annotate operation, Transform operation, Group operation, Sort operation, Union operation, or the like, which will be described in FIGS. 29-35 that follow.

FIG. 28 depicts an exemplary publish operation performed by the data integration mechanism at step 2516 of FIG. 25 in accordance with an illustrative embodiment. As the operation begins, the data integration mechanism receives one or more generic feeds produced by the import or augment operations of the data integration mechanism, binding context, a transformation function selected according to a desired output based on the desired MIME type of the new augmented data resource, and transformation function arguments (step 2802). The data integration mechanism instantiates any variable references in the received inputs using the binding context (step 2804). The data integration mechanism then produces augmented data resources by evaluating the transformation function on the received instantiated inputs (step 2806), with the operation ending thereafter.

FIG. 29 depicts an exemplary operation of an augmentation function that is a Filter operator in accordance with an illustrative embodiment. As the operation begins, the data integration mechanism receives a generic feed and a filter condition as operands (step 2902). The data integration mechanism then initializes a result generic feed value, where the result of the augment function using the Filter operator will be written, to empty (step 2904). The data integration mechanism then determines if there are any more unprocessed entries in the received generic feed (step 2906). If at step 2906 there are no more unprocessed entries in the received generic feed, then the data integration mechanism returns the result generic feed value (step 2908), with the operation ending thereafter.

If at step 2906 there are more unprocessed entries in the received generic feed, then the data integration mechanism retrieves the first or next unprocessed entry from the received generic feed (step 2910). The data integration mechanism then evaluates the filter condition on the payload of the entry (step 2912). The data integration mechanism determines if the result of the filter condition is true (step 2914). If at step 2914 the result of applying the filter condition is not true, then the operation returns to step 2906. If at step 2914 the result of applying the filter condition is true, then the data integration mechanism adds a new entry to the result generic feed value whose payload is the payload of the entry (step 2916), with the operation returning to step 2906 thereafter.

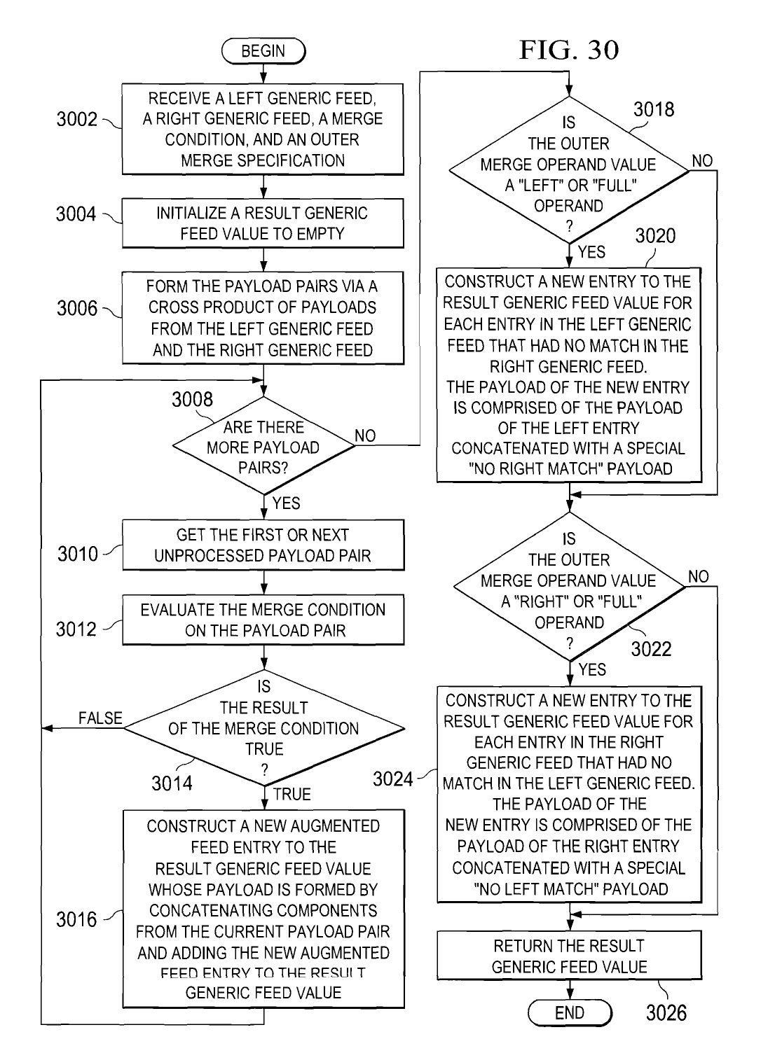

FIG. 30 depicts an exemplary operation of an augmentation function that is a Merge operator in accordance with an illustrative embodiment. As the operation begins, the data integration mechanism receives a left generic feed, a right generic feed, a merge condition, and an outer merge specification, as operands (step 3002). The data integration mechanism initializes a result generic feed value, where the result of the augment operation using the Merge operator will be written, to empty (step 3004). The data integration mechanism then forms payload pairs (left pairs and right pairs) via a cross product of payloads received from left generic feed and the right generic feed (step 3006). The data integration mechanism then determines if there are any more payload pairs associated with the generic feeds (step 3008).

If at step 3008 there are more payload pairs, then the data integration mechanism retrieves the first or next unprocessed payload pair associated with the generic feeds (step 3010). Then the data integration mechanism evaluates the merge condition on the unprocessed payload pair (step 3012). The data integration mechanism determines if the result of the merge condition is true to the unprocessed payload pair (step 3014). If at step 3014 the result of applying the merge condition to the unprocessed payload pair is not true, then the operation returns to step 3008. If at step 3014 the result of applying the merge condition to the unprocessed payload pair is true, then the data integration mechanism constructs a new augmented feed entry to the result generic feed value whose payload is formed by concatenating right feed components and left feed components of the current payload pair and adding the new augmented feed entry to the result generic feed (step 3016), with the operation returning to step 3008 thereafter.

If at step 3008 there are no more payload pairs associated with the generic feeds, then the data integration mechanism determines if the value of the outer merge specification is “left” or “full” (step 3018). If at step 3018 the outer merge specification value is a “left” or “full”, then the data integration mechanism adds a new entry to the result generic feed value for each left entry in the left generic feed that had no match in right generic feed (step 3020). The payload of the new entry is comprised of the payload of left entry concatenated with a special “no right match” payload element. From step 3020, or if at step 3018 the outer merge specification value is not “left” or “full”, then the data integration mechanism determines if the outer merge specification value is “right” or “full” (step 3022). If at step 3022 the outer merge specification value is a “right” or “full”, then the data integration mechanism adds a new entry to the result generic feed value for each right entry in right generic feed that had no match in left generic feed. The payload of the new entry is comprised of the payload of the right entry concatenated with a special “no left match” payload element (step 3024). From step 3024, or if at step 3022 the outer merge specification value is not “right” or “full”, then the data integration mechanism returns the result generic feed value (step 3026), with the operation ending thereafter.

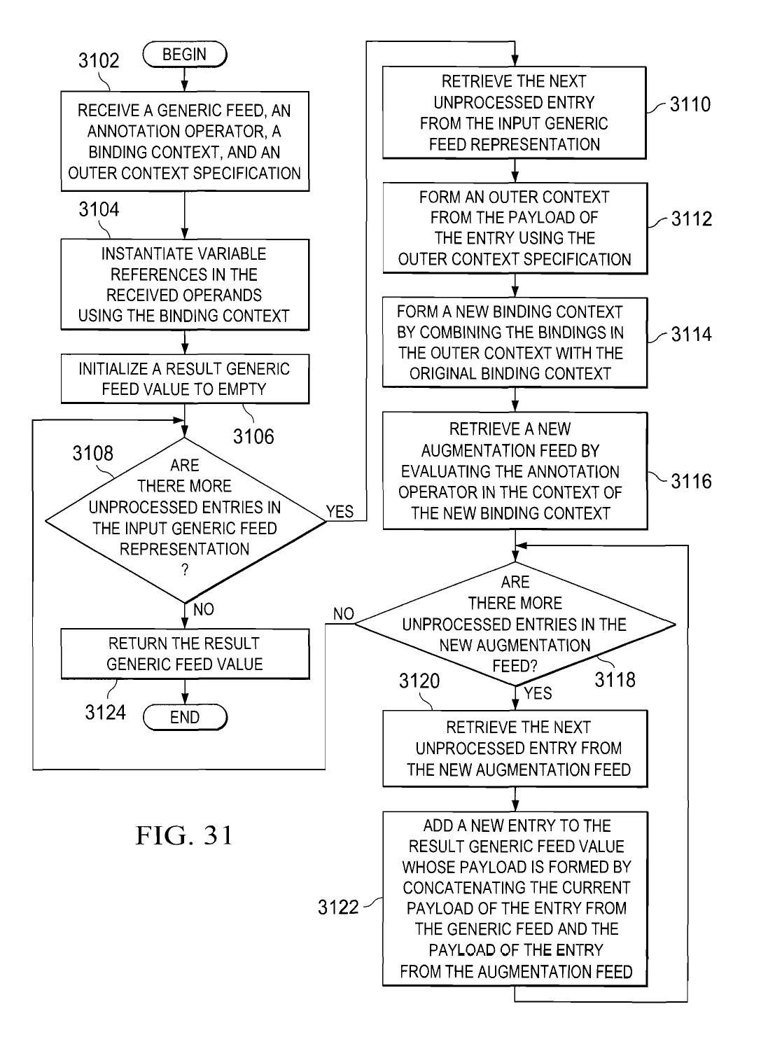

FIG. 31 depicts an exemplary operation of an augmentation function that is an Annotate operator in accordance with an illustrative embodiment. As the operation begins, the data integration mechanism receives a generic feed, an annotation operator, a binding context, and an outer context specification, as operands (step 3102). The data integration mechanism instantiates any variable references in the received operands using the binding context (step 3104). The data integration mechanism then initializes a result generic feed value, where the result of the augment operation using the Annotate operator will be written, to empty (step 3106). The data integration mechanism then determines if there are any more unprocessed entries in the input feed (step 3108).

If at step 3108 there are more unprocessed entries in the input feed, then the data integration mechanism retrieves the first or next unprocessed entry from the input feed (step 3110). The data integration mechanism forms an outer context from the payload of the entry using the outer context specification (step 3112). The data integration mechanism then forms a new binding context by combining bindings in the outer context and the original binding context (step 3114). The data integration mechanism retrieves a new augmentation feed by evaluating the annotation operator in the context of the new binding context (step 3116). The data integration mechanism then determines if there are any more unprocessed augmentation feed entries in the new augmentation feed (step 3118). If at step 3118 there are no more unprocessed augmentation feed entries in the new augmentation feed, then the operation returns to step 3108.

If at step 3118 there are more unprocessed augmentation feed entries in the new augmentation feed, then the data integration mechanism retrieves the first or next unprocessed augmentation feed entry from the new augmentation feed (step 3120). The data integration mechanism adds a new entry to the result generic feed value whose payload is formed by concatenating the current payload of the entry from the input generic feed and the payload of the augmentation feed entry from the new augmentation feed (step 3122), with the operation returning to step 3118 thereafter. If at step 3108 there are no more unprocessed entries in the input feed, then the data integration mechanism returns the result generic feed value (step 3124), with the operation ending thereafter.

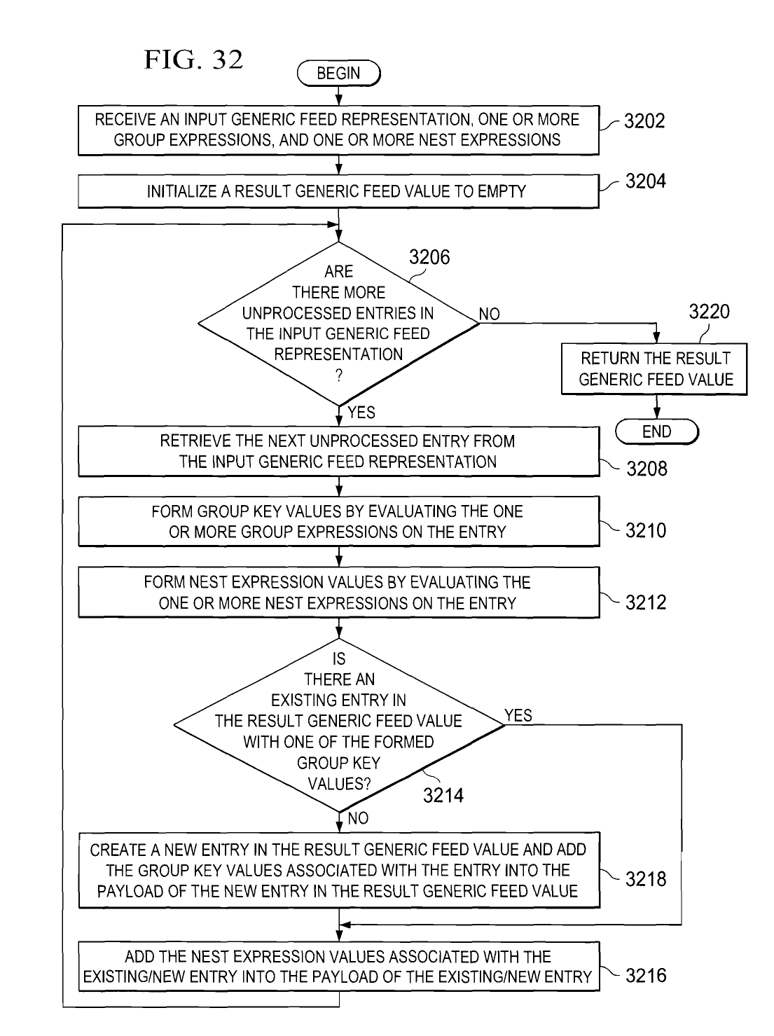

FIG. 32 depicts an exemplary operation of an augmentation function that is a Group operator in accordance with an illustrative embodiment. As the operation begins, the data integration mechanism receives an input generic feed, one or more group expressions, and one or more nest expressions, as operands (step 3202). The data integration mechanism initializes a result generic feed value, where the result of the augment operation using the Group operator will be written, to empty (step 3204). The data integration mechanism then determines if there are any more unprocessed entries in the input feed (step 3206).

If at step 3206 there are more unprocessed entries in the input feed, then the data integration mechanism retrieves the first or next unprocessed entry from the input generic feed (step 3208). The data integration mechanism forms group key values by evaluating the one or more group expressions on the entry (step 3210). The data integration mechanism then forms nest expression values by evaluating the one or more nest expressions on the entry (step 3212). The data integration mechanism then determines if there is an existing entry in the result generic feed value with one of the formed group key values (step 3214). If at step 3214 there is an existing entry in the result generic feed value with one of the formed group key values, then the data integration mechanism adds the nest expression values associated with the existing entry into the payload of the existing entry (step 3216), with the operation returning to step 3206 thereafter.

If at step 3214 there is not an existing entry in the result generic feed value with one of the formed group key values, then the data integration mechanism creates a new entry in the result generic feed value and adds the group key values associated with the entry into the payload of the new entry in the result generic feed value (step 3218). Then the data integration mechanism adds the nest expression values associated with the new entry into the payload of the new entry (step 3216), with the operation returning to step 3206 thereafter. If at step 3206 there are no more unprocessed entries in the input feed, then the data integration mechanism returns the result generic feed value (step 3220), with the operation ending thereafter.

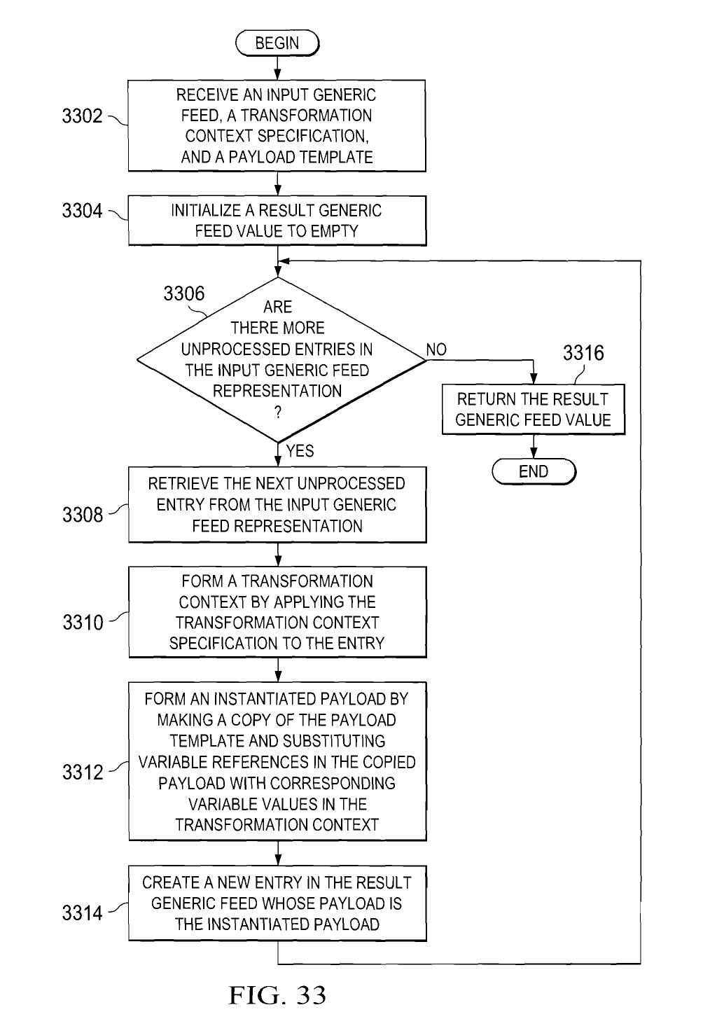

FIG. 33 depicts an exemplary operation of an augmentation function that is a Transform operator in accordance with an illustrative embodiment. As the operation begins, the data integration mechanism receives an input generic feed, a transformation context specification, and a payload template (step 3302). The data integration mechanism initializes a result generic feed value, where the result of the augment operation using the Transform operator will be written, to empty (step 3304). The data integration mechanism then determines if there are any more unprocessed entries in the input generic feed (step 3306).

If at step 3306 there are more unprocessed entries in the input generic feed, then the data integration mechanism retrieves the first or next unprocessed entry from the input generic feed (step 3308). The data integration mechanism forms a transformation context by applying the transformation context specification to the entry (step 3310). The data integration mechanism then forms an instantiated payload by making a copy of the payload template and substituting variable references in the copied payload with the corresponding variable values in the transformation context (step 3312). Then the data integration mechanism creates a new entry in the result generic feed value whose payload is the instantiated payload (step 3314), with the operation returning to step 3306 thereafter. If at step 3306 there are no more unprocessed entries in the input feed, then the data integration mechanism returns the result generic feed value (step 3316), with the operation ending thereafter.

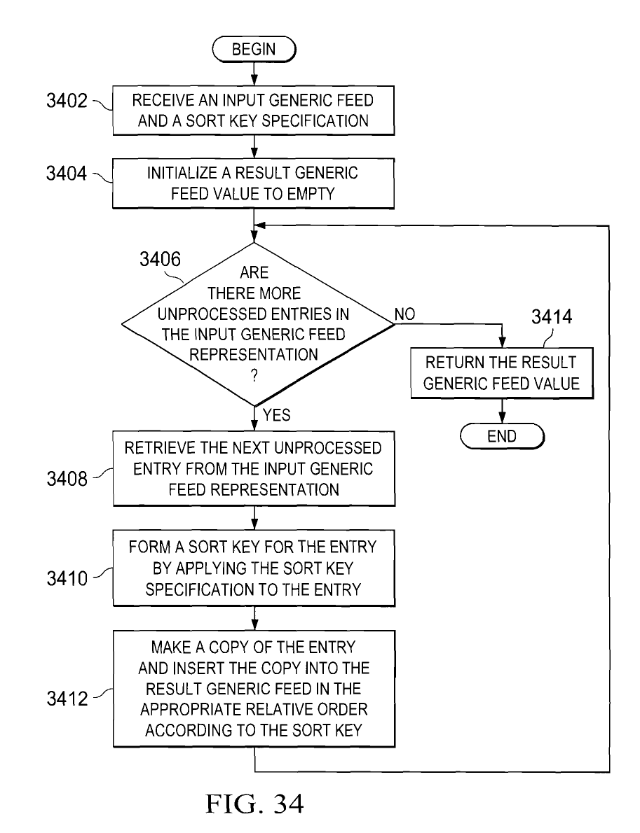

FIG. 34 depicts an exemplary operation of an augmentation function that is a Sort operator in accordance with an illustrative embodiment. As the operation begins, the data integration mechanism receives an input generic feed and a sort key specification (step 3402). The data integration mechanism initializes a result generic feed value, where the result of the augment operation using the Sort operator will be written, to empty (step 3404). The data integration mechanism then determines if there are any more unprocessed entries in the input generic feed (step 3406).

If at step 3406 there are more unprocessed entries in the input feed, then the data integration mechanism retrieves the first or next unprocessed entry from the input generic feed (step 3408). The data integration mechanism forms a sort key for the entry by applying the sort key specification to the entry (step 3410). The data integration mechanism then makes a copy of the entry and inserts the copy into the result generic feed in the appropriate relative order according to the sort key (step 3412) with the operation returning to step 3406 thereafter. If at step 3406 there are no more unprocessed entries in the input generic feed, then the data integration mechanism returns the result generic feed value (step 3414), with the operation ending thereafter.

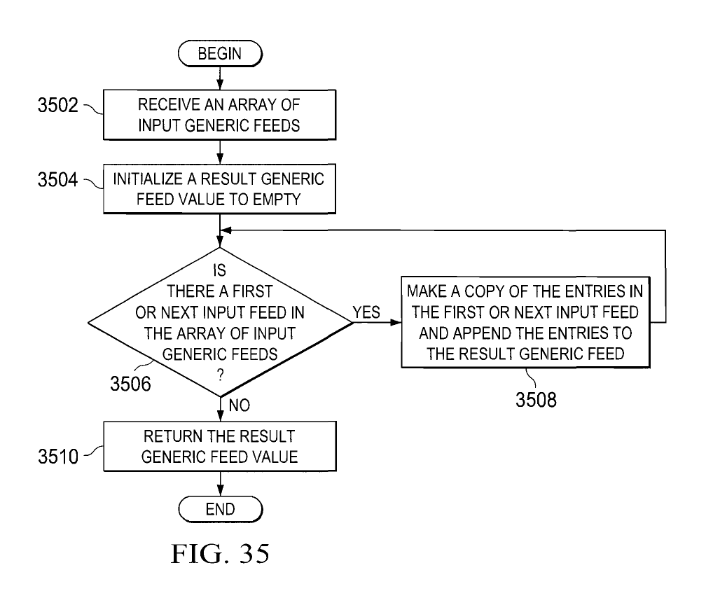

FIG. 35 depicts an exemplary operation of an augmentation function that is a Union operator in accordance with an illustrative embodiment. As the operation begins, the data integration mechanism receives an array of input generic feeds (step 3502). The data integration mechanism initializes a result generic feed value, where the result of the augment operation using the Union operator will be written, to empty (step 3504). The data integration mechanism determines if there is a first or next input feed in the array of input generic feeds (step 3506). If at step 3506 there is a first or next input feed in the array of input generic feeds, the data integration mechanism makes a copy of the entry(ies) in input feed and appends the entry(ies) to the result generic feed value (step 3508), with the operation returning to step 3506 thereafter. If at step 3506 there are no more input feeds in the array of input generic feeds, then the data integration mechanism returns the result generic feed value (step 3510), with the operation ending thereafter.

Thus, the illustrative embodiments provide a mechanism for data integration that allows enterprise mashups to be built quickly and easily. The data integration mechanism performs data integration logic of an application, thereby allowing the enterprise mashup developer to focus on the application's business logic. In particular, the illustrative embodiments disclose a mechanism for data integration that enables access to various types of data resources, provides the capability to integrate and augment the data resources retrieved from those sources, and allows for the further transformation and delivery of the augmented data to all types of applications.

As noted above, it should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) may be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for data integration in a data processing system comprising:
receiving a data mashup specification; and
executing an interleaved sequence of operations as defined by the data mashup specification, wherein the interleaved sequence of operations comprises at least one of an import operation, an augment operation, or a publish operation and wherein executing the interleaved sequence of operations comprises:
determining a next operation to execute;
forming an outer context;
adding the outer context to a binding context of the next operation;
responsive to the next operation being the import operation, importing a data resource from a data source and generating an input generic feed.

2. The method of claim 1, wherein importing the data resource from the data source and generating the generic feed further comprises:
receiving inputs comprising a protocol, a data resource locator, a repeating element, and a binding context;
instantiating variable references in the received inputs using the binding context;
retrieving the data resource from the data source by using the protocol and data resource locator;
selecting an ingestion function based on a Multipurpose Internet Mail Extensions (MIME) type of the data resource;
translating the data resource to an XML representation of the data resource by applying the ingestion function;
extracting a set of payloads from the XML representation using the repeating element;
constructing a new feed entry from each extracted payload; and
adding each new feed entry to the generic feed.

3. The method of claim 1, further comprising:
responsive to the next operation being the augment operation, producing augmented generic feed from a set of input generic feeds, wherein producing the augmented generic feed from the set of input generic feeds further comprises:
receiving inputs comprising the set of input generic feeds, a binding context, an augmentation function, and augmentation function arguments;
instantiating variable references in the received inputs using the binding context; and
evaluating the augmentation function on the instantiated received inputs to produce an augmented generic feed.

4. The method of claim 3, wherein the augmentation function is at least one of a Filter operation, a Merge operation, a Transform operation, a Group operation, a Sort operation, a Union operation, or an Annotate operation.

5. The method of claim 4, wherein producing the augmented generic feed from the set of input generic feeds by evaluating the augmentation function that is the Filter operation comprises:
applying a filter condition to each payload of the set of input generic feeds;
responsive to a result of the filter condition, constructing a new feed entry from each payload; and
adding the new feed entry to the augmented generic feed.

6. The method of claim 4, wherein a left generic feed and a right generic feed is received and wherein producing the augmented generic feed from the right and the left generic feeds by evaluating the augmentation function that is the Merge operation comprising a merge condition and an outer merge specification further comprises:
forming sets of payload pairs via a cross product of one or more payloads of the left generic feed and one or more payloads of the right generic feed;
applying the merge condition to each set of payload pairs;
responsive to a result of the merge condition, constructing a new augmented feed entry by concatenating right feed components and left feed components of each set of payload pairs; and
adding the new augmented feed entry to the augmented generic feed.

7. The method of claim 6, further comprising:
responsive to the outer merge specification being a “left” or “full” operand, constructing the new augmented generic feed entry from each payload of the left generic feed that does not have a match in the right generic feed according to the merge condition; and
adding the new augmented feed entry to the augmented generic feed.

8. The method of claim 6, further comprising:
responsive to the outer merge specification being a “right” or “full” operand, constructing the new augmented generic feed entry from each payload of the right generic feed that does not have a match in the left generic feed according to the merge condition; and
adding the new augmented feed entry to the augmented generic feed.

9. The method of claim 4, wherein an annotation operator and outer context specification are received and wherein producing the augmented generic feed from the set of input generic feeds by evaluating the augmentation function that is the Annotate operation comprises:
forming an new outer context for each payload of the set of input generic feeds;
combining bindings in the new outer context with bindings in a binding context to form a new binding context for each payload of the set of input generic feeds;
evaluating the annotation operator in a context of each new binding context to determine an augmentation feed associated with each payload of the set of input generic feeds; and
adding a new entry to the augmented generic feed that is formed by concatenating each payload of the set of input generic feeds with each payload of its associated augmentation feed.

10. The method of claim 4, wherein one or more group expressions and one or more nest expressions are received and wherein producing the augmented generic feed from the set of input generic feeds by evaluating the augmentation function that is the Group operation comprises:
evaluating the one or more group expressions on a payload of each entry of the set of input generic feeds to form an associated set of group key values;
evaluating the one or more nest expressions on the payload of each entry of the set of input generic feeds to form an associated set of nest expression values;
for each entry of the set of input generic feeds, associated set of group key values, and associated set of nest expression values, determining if there is an existing entry in the augmented generic feed with corresponding group key values;
responsive to an absence of the existing entry, constructing a new augmented feed entry that incorporates the associated set of group key values;
adding the new augmented feed entry to the augmented generic feed; and
responsive to an existence of the existing entry, adding the associated set of nest expression values to the existing entry.

11. The method of claim 4, wherein a transformation context and a payload template are received and wherein producing the augmented generic feed from the set of input generic feeds by evaluating the augmentation function that is the Transform operation comprises:
forming a transformation context for each payload of the input generic feed;
forming an instantiated payload by copying the payload template and substituting variable references in the copied payload with corresponding variable values in the transformation context; and
adding a new feed entry to the augmented generic feed whose payload is the instantiated payload.

12. The method of claim 4, wherein a sort key specification is received and wherein producing the augmented generic feed from the set of input generic feeds by evaluating the augmentation function that is the Sort operation comprises:
forming a sort key for each payload of the input generic feed by applying the sort key specification to each payload of the input generic feed; and
adding a copy of the payload to the augmented generic feed in an appropriate relative order according to the sort key.

13. The method of claim 4, wherein an array of input generic feeds are received and wherein producing the augmented generic feed from the set of input generic feeds by evaluating the augmentation function that is the Union operation comprises:
for each input feed of a plurality of input feeds, appending a copy of all entries of the input feed to the augmented generic feed.

14. The method of claim 1, further comprising:
responsive to the next operation being the publish operation, producing a new data resource from a specified augmented generic feed, wherein producing the new data resource from the specified augmented generic feed further comprises:
receiving inputs comprising the specified augmented generic feed, the binding context, a transformation function selected according to a desired output based on a desired MIME type of the new data resource, and transformation function arguments;
instantiating variable references in the received inputs using the binding context; and
evaluating the transformation function with the instantiated received inputs to produce the new data resource.

16. A method for data integration in a data processing system comprising:
receiving a data mashup specification; and
executing an interleaved sequence of operations as defined by the data mashup specification, wherein the interleaved sequence of operations comprises at least one of an import operation, an augment operation, or a publish operation and wherein executing the interleaved sequence of operations comprises:
determining a next operation to execute;
forming an outer context;
adding the outer context to a binding context of the next operation;
responsive to the next operation being the augment operation, producing a set of augmented generic feeds from a set of input generic feeds.

17. A method for data integration in a data processing system comprising:
receiving a data mashup specification; and
executing an interleaved sequence of operations as defined by the data mashup specification, wherein the interleaved sequence of operations comprises at least one of an import operation, an augment operation, or a publish operation and wherein executing the interleaved sequence of operations comprises:
determining a next operation to execute;
forming an outer context;
adding the outer context to a binding context of the next operation;
responsive to the next operation being the publish operation, producing a new data resource from a specified augmented generic feed.

18. A computer program product comprising a computer recordable medium having a computer readable program recorded thereon, wherein the computer readable program, when executed on a computing device, causes the computing device to:
receive a data mashup specification; and
execute an interleaved sequence of operations as defined by the data mashup specification, wherein the interleaved sequence of operations comprises at least one of an import operation, an augment operation, or a publish operation and wherein the computer readable program to execute the interleaved sequence of operations further causes the computing device to:
determine a next operation to execute;
form an outer context;
add the outer context to a binding context of the next operation;
responsive to the next operation being the import operation, import a data resource from a data source and generate an input generic feed;
responsive to the next operation being the augment operation, produce an augmented generic feed from a set of input generic feeds; and
responsive to the next operation being the publish operation, produce a new data resource from a specified augmented generic feed.

19. The computer program product of claim 18, wherein the computer readable program to import the data resource from the data source and generating the generic feed further causes the computing device to:
receive inputs comprising a protocol, a data resource locator, a repeating element, and a binding context;
instantiate variable references in the received inputs using the binding context;
retrieve the data resource from the data source by using the protocol and data resource locator;
select an ingestion function based on a Multipurpose Internet Mail Extensions (MIME) type of the data resource;
translate the data resource to an XML representation of the data resource by applying the ingestion function;
extract a set of payloads from the XML representation using the repeating element;
construct a new feed entry from each extracted payload; and
add each new feed entry to the generic feed.

20. The computer program product of claim 18, wherein the computer readable program to produce the augmented generic feed from the set of input generic feeds further causes the computing device to:
receive inputs comprising the set of input generic feeds, a binding context, an augmentation function, and augmentation function arguments;
instantiate variable references in the received inputs using the binding context; and
evaluate the augmentation function on the instantiated received inputs to produce the augmented generic feed, wherein the augmentation function is at least one of a Filter operation, a Merge operation, a Transform operation, a Group operation, a Sort operation, a Union operation, or an Annotate operation.

21. The computer program product of claim 18, wherein the computer readable program to produce the new data resource from the specified augmented generic feed further causes the computing device to:
receive inputs comprising the specified augmented generic feed, the binding context, a transformation function selected according to a desired output based on a desired MIME type of the new data resource, and transformation function arguments;
instantiate variable references in the received inputs using the binding context; and
evaluate the transformation function with the instantiated received inputs to produce the new data resource.

22. An apparatus, comprising:
a processor; and
a memory coupled to the processor, wherein the memory comprises instructions which, when executed by the processor, cause the processor to:
receive a data mashup specification; and
execute an interleaved sequence of operations as defined by the data mashup specification, wherein the interleaved sequence of operations comprises at least one of an import operation, an augment operation, or a publish operation and wherein the computer readable program to execute the interleaved sequence of operations further causes the computing device to:
determine a next operation to execute;
form an outer context;
add the outer context to a binding context of the next operation;
responsive to the next operation being the import operation, import a data resource from a data source and generate an input generic feed;
responsive to the next operation being the augment operation, produce an augmented generic feed from a set of input generic feeds; and
responsive to the next operation being the publish operation, produce a new data resource from a specified augmented generic feed.

23. The apparatus of claim 22, wherein the instructions to import the data resource from the data source and generating the generic feed further cause the processor to:
receive inputs comprising a protocol, a data resource locator, a repeating element, and a binding context;
instantiate variable references in the received inputs using the binding context;
retrieve the data resource from the data source by using the protocol and data resource locator;
select an ingestion function based on a Multipurpose Internet Mail Extensions (MIME) type of the data resource;
translate the data resource to an XML representation of the data resource by applying the ingestion function;
extract a set of payloads from the XML representation using the repeating element;
construct a new feed entry from each extracted payload; and
add each new feed entry to the generic feed.

24. The apparatus of claim 22, wherein the instructions to produce the augmented generic feed from the set of input generic feeds further cause the processor to:
receive inputs comprising the set of input generic feeds, a binding context, an augmentation function, and augmentation function arguments;
instantiate variable references in the received inputs using the binding context; and
evaluate the augmentation function on the instantiated received inputs to produce the augmented generic feed, wherein the augmentation function is at least one of a Filter operation, a Merge operation, a Transform operation, a Group operation, a Sort operation, a Union operation, or an Annotate operation.

25. The apparatus of claim 18, wherein the instructions to produce the new data resource from the specified augmented generic feed further cause the processor to:
receive inputs comprising the specified augmented generic feed, the binding context, a transformation function selected according to a desired output based on a desired MIME type of the new data resource, and transformation function arguments;
instantiate variable references in the received inputs using the binding context; and
evaluate the transformation function with the instantiated received inputs to produce the new data resource.
